(19) United States
(12) Patent Application Publication
(10) Pub. No.: US 2026/0134737 A1
(43) Pub. Date: May 14, 2026

(54) Automated System for Food and/or Beverage Preparation

(71) Applicant: Gastronomous Technologies Inc., Oakville (CA)

(72) Inventors: Andrew SKREPNEK, Burlington (CA); Kristian TAZBAZIAN, Oakville (CA); Kevork SEVADJIAN, Oakville (CA)

(73) Assignee: Gastronomous Technologies Inc., Oakville (CA)

(21) Appl. No.: 19/442,778

(22) Filed: Jan. 7, 2026

Related U.S. Application Data
(63) Continuation of application No. PCT/CA2024/050915, filed on Jul. 8, 2024.
(60) Provisional application No. 63/512,496, filed on Jul. 7, 2023.

(51) Int. Cl. G07F 13/06; B65G 54/02; G07F 13/10

(52) U.S. Cl. CPC G07F 13/065; B65G 54/02; G07F 13/10; B65G 2201/0235

(57) ABSTRACT

An automated system for food and/or beverage preparation is provided. The system includes one or more path segments that together form a path between a plurality of preparation stations, the path segments being positioned beneath a surface on which the preparation stations are positioned. Each path segment includes a segment path element; a guide actuator moveable along the segment path element; and a magnetic guide, the magnetic guide being controllable to couple the magnetic guide to a magnetic portion of an object placed above the magnetic guide on the surface.

### CROSS-REFERENCE TO RELATED APPLICATION(S)

This application is a Continuation of PCT Patent Application No. PCT/CA2024/050915 filed on Jul. 8, 2024, which claims priority to U.S. Provisional Patent Application No. 63/512,496 filed on Jul. 7, 2023, the entire contents of which are incorporated herein by reference.

### TECHNICAL FIELD

The following generally relates to automation systems for food and/or beverage preparation and, more particularly, to systems operable to autonomously move an item through one or more stations in a food and/or beverage preparation line.

### BACKGROUND

The preparation of food and/or beverages can be time consuming and labor intensive, particularly when there are multiple steps in the preparation process. For example, preparing a cup of coffee may require the selection of a cup of the desired size, the addition of sugar (or artificial sweeteners) and/or dairy (or non-dairy substitutes) products, and the filling of the cup with the coffee, stirring the contents, and adding a lid. Similar steps are often required for other beverages such as specialty cold and hot café drinks. Likewise, the preparation of some food products, such as a hamburger may involve the progression through certain stations, e.g., to add condiments and prepare the item all the way to final delivery to the customer.

While many food and beverage preparation lines are optimized or at least organized to streamline the operations for the user, they still typically require at least one but more often many individual steps that are prone to human error and require available staff to ensure a desired throughput.

### SUMMARY

An automation system is provided, which enables a food and/or beverage preparation line to include at least one automated step or stage in which the food, beverage and/or its receptacle is moved over a surface to interact with equipment used for that stage.

In one aspect, there is provided an automated system for food and/or beverage preparation, comprising: one or more path segments that together form a path between a plurality of preparation stations, the path segments being positioned beneath a surface on which the preparation stations are positioned, each path segment comprising: a segment path element; a guide actuator moveable along the segment path element; and a magnetic guide, the magnetic guide being controllable to couple the magnetic guide to a magnetic portion of an object placed above the magnetic guide on the surface.

In certain example embodiments, the system further includes a computing system, the computing system being connected to the guide actuator of each of the one or more path segments, the computing system comprising a controller operable to have the guide actuator move along its segment path element and operable to couple and decouple the magnetic guide to selectively interact with the object.

In certain example embodiments, the computing system is coupled to at least one dispensing equipment at a corresponding preparation station to selectively operate the dispensing equipment when the receptacle is positioned at that station and/or attached to a piece of equipment.

In certain example embodiments, the object placed above the magnetic guide on the surface comprises a receptacle.

In certain example embodiments, the computing system further comprises a main controller coupled to a plurality of sensor and actuator controllers to control the guide actuators according to sensor inputs.

In certain example embodiments, the main controller is coupled to a machine vision system to apply a food/beverage item recognition program as an input to determine a preparation sequence.

In certain example embodiments, the system further includes a user interface coupled to the controller.

In certain example embodiments, the system further includes at least one data interface to provide preparation log data.

In certain example embodiments, the system includes a network interface for communicating between multiple electro-mechanical systems.

In certain example embodiments, the system includes a network data interface for sending log data to a central server.

In certain example embodiments, the system further includes an indexing mechanism to determine a position of the guide actuators.

In certain example embodiments, the object comprises a receptacle to interact with the magnetic guide, the receptacle configured to receive a cup into which contents are dispensed from the preparation stations.

In certain example embodiments, at least one segment comprises a gantry providing two-dimensional movements of at least one magnetic guide to permit non-linear advancement of the object between at least two positions.

In certain example embodiments, the system comprises a cup dropping station, the cup dropping station being activated to drop the cup into the receptacle.

In certain example embodiments, the system comprises at least one beverage dispensing station elevated relative to the cup, the system being configured to move the cup into alignment with the beverage dispensing station.

In certain example embodiments, the system further comprises an offload station on the surface for accommodating at least one cup and receptacle subsequent to being subjected to at least one of the preparation stations.

In certain example embodiments, the system further comprises a return path for automatically returning the object from an end station to a beginning station.

In certain example embodiments, the surface is provided in an enclosed unit that is supportable upon an existing surface.

In certain example embodiments, at least one preparation station comprises a valve, the valve being automatically operated by a valve actuator connected to a controller in the system.

In certain example embodiments, the system further comprises a labelling or printing station comprising a printer or labeler that is automatically activated to apply information to an item coupled to and carried by the object between the preparation stations.

In certain example embodiments, the system further comprises a user interface module to provide a screen to interface with at least some of the preparation stations.

In certain example embodiments, at least one preparation station comprises a plurality of liquid dispensing urns positioned above the surface to permit the object, loaded with a cup, to be positioned beneath a selected one of the urns.

In certain example embodiments, a plurality of objects with cups are positioned under respective urns at the same time, and wherein at least two objects are moved from the preparation station to another station at the same time.

### BRIEF DESCRIPTION OF THE DRAWINGS

Embodiments will now be described with reference to the appended drawings wherein:

FIG. 1a is a perspective view of an example of a beverage preparation line.

FIG. 1b is a perspective view of another example of a beverage preparation line.

FIG. 2a is a perspective view of the example beverage preparation line in FIG. 1a, illustrating an automated path for a cup.

FIG. 2b is a perspective view of the example beverage preparation line in FIG. 1b, illustrating an automated path for a cup.

FIGS. 3a and 3b are cross-sections of a cup placed in a receptacle.

FIGS. 3c, 3d-i, 3d-ii, 3e and 3f are top, side, cross-section and perspective views of a receptacle, including an optional two-piece insert configuration.

FIGS. 4a to 4d illustrate a hand off procedure between adjacent path sections.

FIGS. 5a to 5d illustrate a hand off procedure between adjacent path sections in another example.

FIGS. 6a to 6c illustrate a hand off procedure between adjacent and perpendicular path sections.

FIG. 7 illustrates another example configuration for a magnetic guide.

FIG. 8 is a plan view illustrating a path for the example beverage preparation line of FIGS. 1 and 2.

FIG. 9 illustrates a set of path segments with magnetic guides aligned to execute the path shown in FIG. 8.

FIG. 10a is a plan view of the example configuration shown in FIGS. 1b and 2b.

FIG. 10b is a side view of the example configuration shown in FIGS. 1b and 2b.

FIG. 10c is an end view of the example configuration shown in FIGS. 1b and 2b.

FIG. 11a is a perspective view of a drive system configured to control automated pathways for the configuration shown in FIGS. 1b and 2b.

FIG. 11b is a plan view of the drive system of FIG. 11a.

FIG. 11c is an elevation view of the drive system of FIG. 11a.

FIG. 12 is a perspective view of a linear actuator.

FIG. 13a is a perspective view of a beverage urn shelf in isolation.

FIG. 13b is a plan view of the beverage urn shelf.

FIG. 13c is an elevation view of the beverage urn shelf.

FIG. 14a is a perspective view of an urn actuator.

FIGS. 14b, 14c, and 14d are top, front and side views of the urn actuator.

FIG. 15a is a perspective view of a cup dropper assembly.

FIGS. 15b, 15c, and 15d are top, side and front views of the cup dropper assembly.

FIG. 16a is a perspective view of an inkjet printer.

FIGS. 16b, 16c, and 16d are top, front and side views of the inkjet printer.

FIG. 17a is a perspective view of a receptacle return lane.

FIGS. 17b, 17c, and 17d are top, side and front views of the receptacle return lane.

FIG. 18a is a perspective view of a user interface module.

FIGS. 18b, 18c, and 18d are top, front and side views of the user interface module.

FIG. 19 is a schematic diagram of an automation system integration with a food and/or beverage preparation line.

FIG. 20 is a flow chart illustrating example operations that can be performed in advancing a receptacle through a series of segments in a food and/or beverage preparation line.

FIG. 21 is a flow chart illustrating example operations that can be performed in performing a hand off procedure to pass a receptacle from one segment to the next.

FIG. 22 is a flow chart illustrating example operations that can be performed in activating a dispensing station in a food and/or beverage preparation line.

FIG. 23 is a schematic diagram illustrating an example of an automated system for beverage preparation for the configuration shown in FIGS. 1a and 2a.

FIG. 24 is a schematic diagram illustrating an example of an automated system for beverage preparation for the configuration shown in FIGS. 1b and 2b.

FIG. 25 is a flow chart illustrating example operations that can be performed at a cup dropping station.

FIG. 26 is a flow chart illustrating example operations that can be performed by a labelling and additives station.

FIG. 27 is a flow chart illustrating example operations that can be performed at a dispense and drop off station.

FIG. 28 is a flow chart illustrating example operations that can be performed at a dispense station.

FIG. 29 is a flow chart illustrating example operations that can be performed at an offload station.

FIG. 30 is a flow chart illustrating example operations that can be performed by the system integrating with a point-of-sale (POS) system.

FIG. 31 is a flow chart illustrating example user interactions with the system.

FIG. 32 is a screen shot of an example of a user interface for interacting with the system.

### DETAILED DESCRIPTION

To enable a food and/or beverage preparation line (hereinafter generally referred to as a “preparation line”) to include at least one automated step, the following system enables movement along a plurality of path segments by placing magnetic guides operable using actuators that travel along segment paths beneath a surface. The magnetic guides and actuators use magnetic attraction between the magnetic guides positioned beneath the counter surface and a magnetic or ferrous material (e.g., a magnet) embedded or otherwise included with or within a receptacle placed atop the counter surface. In this way, as the magnetic guides travel along the segment paths while the guides are magnetically coupled to the receptacle, the receptacle will follow the same path along the counter surface. The segment paths can therefore be aligned with portions of a desired controlled motion path for the receptacle to enable the receptacle to be placed at or with equipment at various equipment stations sitting atop the counter surface. The system described herein can be integrated with the equipment stations to enable automated actuation of the corresponding function while also enabling manual intervention or participation as desired. Since each segment path includes at least one magnetic guide that can move along the corresponding segment path using a corresponding actuator, multiple stages of the same preparation line can be executed simultaneously, with different preparation instructions applicable to each receptacle by using an identification process.

An advantage of the system described herein is that the drive mechanism can be relatively low profile and thus can be seamlessly placed onto an existing countertop in a food service or other food preparation environment. Moreover, the drive system can be completely sealed beneath the working surface to prevent contamination of food and liquids entering the drive system, which provides a significant benefit over conveyor and other exposed systems.

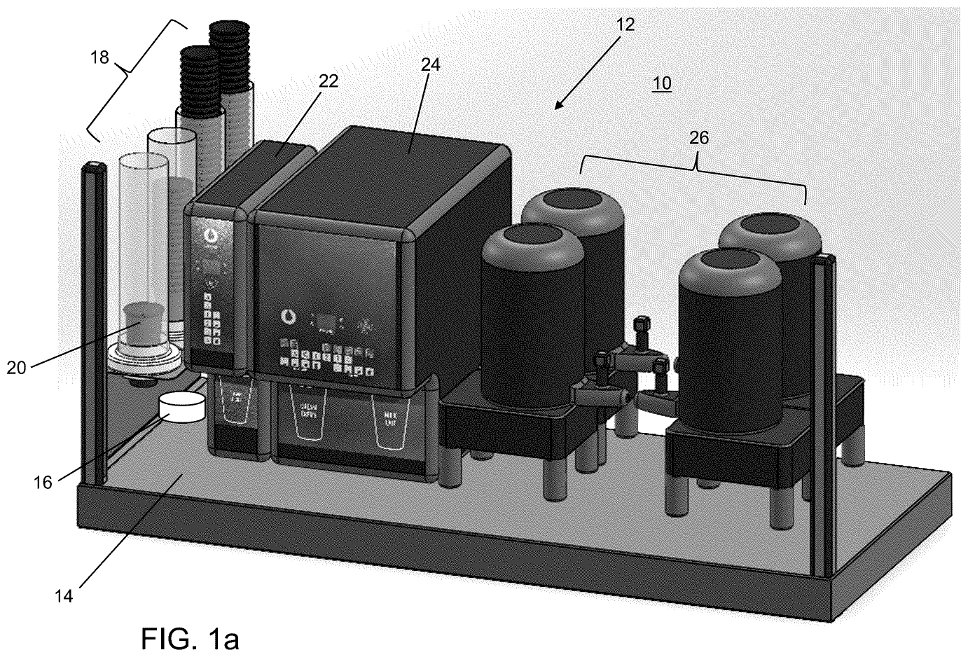

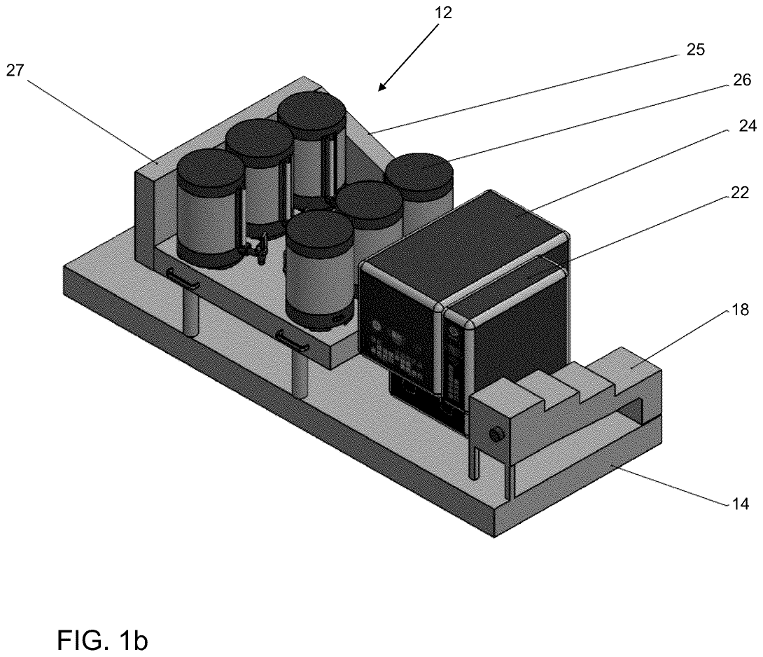

Turning now to the figures, FIG. 1a illustrates an example of a beverage preparation line 12 having a counter surface 14 on which a receptacle 16 can be placed and may slide along. While the example given in FIG. 1a includes a receptable 16 that is configured to hold, support or otherwise contain something else, it can be appreciated that the principles discussed herein may equally apply to any object that the system desires to move along and over the counter surface 14. The surface 14 may be treated with a coating to facilitate movement thereover (e.g., diamond-like carbon to increase hardness and increase wear resistance). For example, the receptacle 16 could take the form of a sponge, wipe or other element that directly contacts the counter surface 14 and is moved thereover by the system described herein. The receptacle 16 is movable in an automated fashion between a number of preparation stations, to be described by way of example. In this example, the receptacle 16 can align with a cup dispensing station 18, which includes a set of dispensing sleeves each holding a sleeve of cups 20, e.g., with one sleeve per cup size as is common with coffee or other soft beverages. It can be appreciated that multi-unit cup dispensers can also be accommodated where there are many cup sizes in the same dispenser and the example shown is purely illustrative of one example. The receptacle 16 can be moved along a path over the surface 14 towards a sugar dispensing machine 22, then a dairy dispensing machine 24, and then a to a coffee pouring zone having one or more urns 26 or other containers of coffee to be poured into a cup 20. It can also be appreciated that the stations shown in FIG. 1a are illustrative only and various stations may be added or omitted. For example, while not shown in FIG. 1a, a labelling station, a stirring station, and/or a lidding station, may also be incorporated.

FIG. 1b illustrates another example of a beverage preparation line 12. In the configuration shown in FIG. 1b, the urns 26 are elevated above the surface 14 to permit additional area in which the receptacles 16 can move. That is, the urns 26 may be elevated (as discussed further below) to permit the cups 20 to be moved under the urns 26 with freer movements. While the configuration shown in FIG. 1b includes six (6) urns 26, it can be appreciated that other configurations may include a different number of urns 26 such as four (4) or eight (8). The urns 26 may be arranged linearly as shown or staggered or stacked or otherwise at different heights. The line 12 shown in FIG. 1b also includes a stepped cup dropper 18 with a ledge for each of a plurality of cup sizes, for example, small, medium, large, and extra-large. To the rear of the urns 26, the dispensing machines 22, 24 is a return ramp 25 to permit a user to return a receptacle 16 that is no longer being used from a serving end (past the urns 26) back to a cup loading zone, at or adjacent to the cup dropper 18. The configuration shown in FIG. 1b also includes a user interface module 27, positioned at one end of the line 12 to provide controls, feedback, and data to the user at the serving end of the line 12. The user interface module 27 may be implemented in other ways, for example by being integrated into the surface 14 or by projecting an image onto the surface 14 to name examples. It can be appreciated that other manual stations may be incorporated into the system shown, i.e., stations that permit preparation of part of an order that is not necessarily automated.

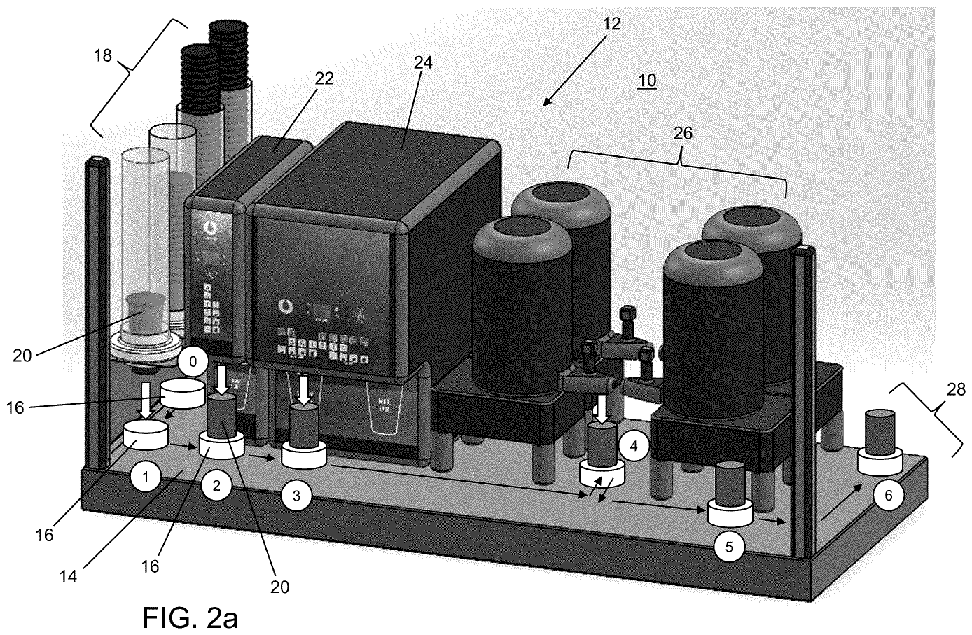

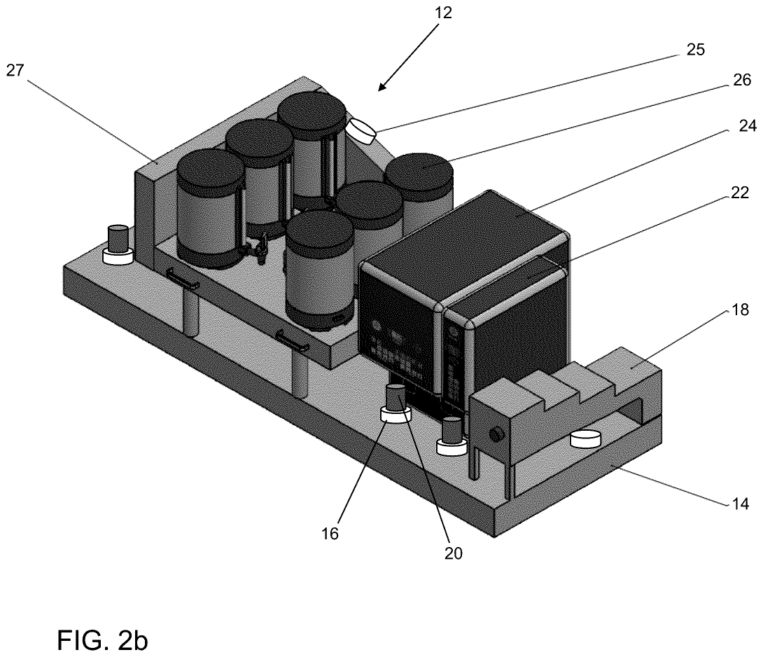

FIG. 2a illustrates the progression of a specific path that uses the stations described above with respect to FIG. 1a. Here, for example, the receptacle begins at station 0, wherein it is activated based on receiving an order (e.g., either directly via a user's point of sale (POS) system, or via manual input to the machine) and is moved to station 1 at which a cup 20 is released from its sleeve 18 and inserted in the receptacle 16. The receptacle 16 (with cup 20) is then advanced to station 2 where sugar is added. Then, the receptacle 16 and cup 20 are advanced to station 3 to receive a shot or multiple shots of dairy according to the customer's specifications and the size of the cup 20. The path continues by advancing the receptacle 16 and cup 20 towards and then into the coffee pouring zone 26 to coffee station 4 by effecting a perpendicular shift into alignment with an urn 26 that contains the desired beverage (e.g., a type of coffee). This may include an urn optimization determination as discussed later. After the cup 20 is filled, the receptacle 16 and cup 20 are moved out of the coffee pouring zone 26 and along an exit path 5 and towards a finish station 6. At the finish station 6, the cup 20 can be retrieved by or for the customer. The receptacle 16, once emptied at station 6, can be either manually or automatically returned to station 0. For example, the surface 14 can be extended behind the stations 22, 24, 26 such that the receptacle 16 can travel along a return path (not shown) to repeat the process. In another example, the receptacle 16 can travel along the path segments taken to arrive at station 6 (with the exception of station 4) when another cup 20 is not in the process of being prepared.

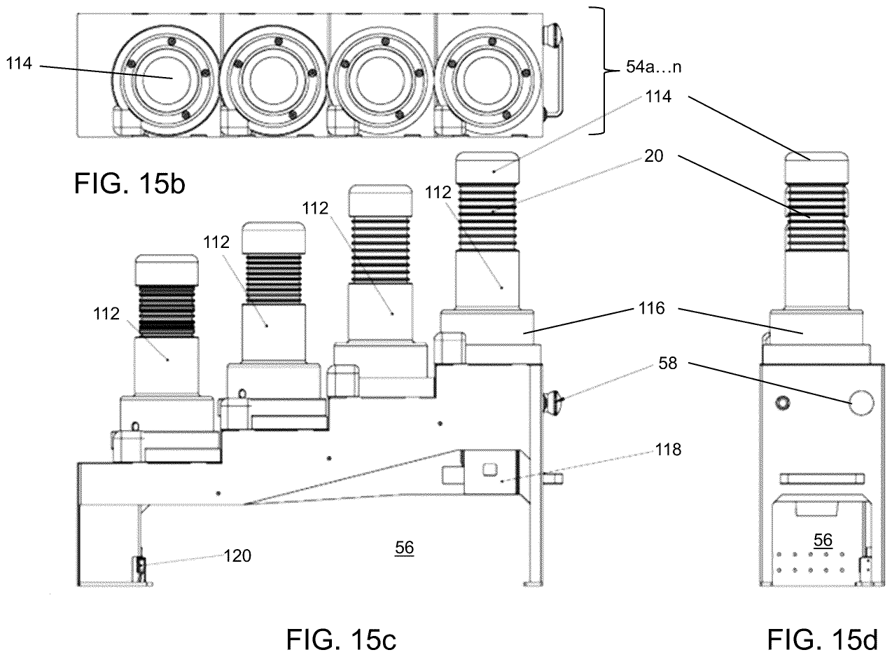

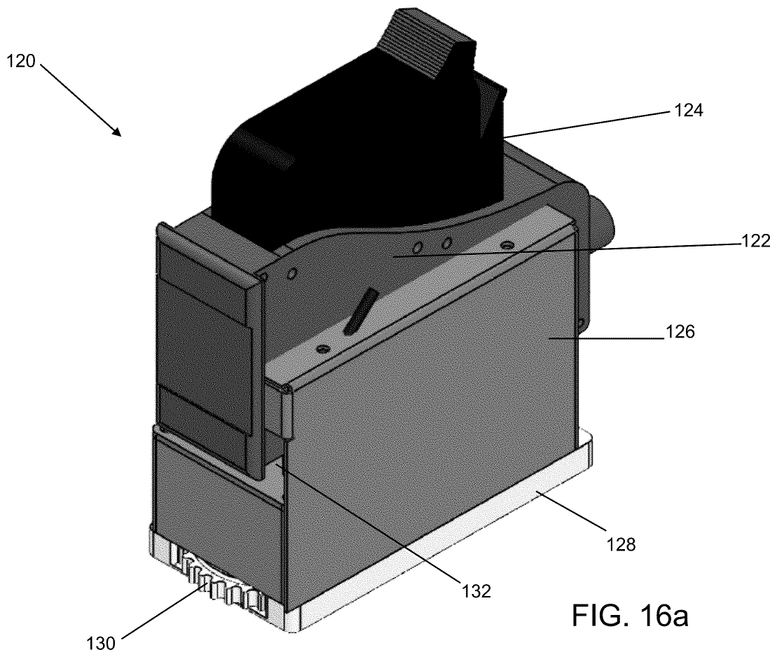

FIG. 2b illustrates a receptacle 16 loaded with a cup 20 in the line 12 shown in FIG. 1b. The progression of the receptacle 16 on its own and receptacle 16 holding a cup 20 is partially shown in FIG. 2b. FIG. 2b illustrates that the receptacle 16 can be returned along the return path 25 at stage R. The principles discussed above and shown in FIG. 2a can be adapted to a different path and progression in FIG. 2b in the same manner as that discussed above and further below. Also shown in FIG. 2b are track lines 21. Although the track lines 21 are visible on the surface 14 in FIG. 2b it can be appreciated that this is only illustrative. Also shown in FIG. 2b is an inkjet module 120 (see also FIG. 16 described below). The inkjet module 120 is an example of a more general “printing/labelling station” that may be used to apply order markings or indicia, which may be printed directly onto the cup, applied using a label (i.e., a labeler may be used in addition or instead of inkjet module 120) or other medium. While not shown in FIG. 2b, the urns 26 contain a limited amount of beverage and need to be replaced periodically or removed and filled periodically. To avoid the steps required to do so, the brewing machines (not shown) can be configured to brew directly into the urns 26 or the urns 26 may be replaced with combined brewing/dispensing units. Similarly, the brewers could be adapted to include feed lines that directly deliver beverage into the urns 26 continuously or at intervals (e.g., once a filled urn 26 is emptied during normal use). In such an implementation, brewers can analyze historical data of sales and determine when to brew.

FIGS. 2a and 2b illustrate that even with similar modules, the system provides numerous configurable options for arranging the stages. FIG. 2b illustrates an example of five (5) stages and a return path or stage (R). Stage 1 may be referred to herein as a cup dropping stage in which the receptacle 16 is dropped or otherwise placed at the cup dropper 18, the receptacle 16 s moved into position below an associated cup size for that particular beverage, the cup 20 is dropped into the receptacle 16, and the receptacle 16 is moved to an end position in stage 1 wherein the receptacle 16 is handed off to Stage 2. At stage 2, the receptacle 16 is picked up from the stage 1 end position and moved to a label/printing station, e.g., the inkjet printer module 120 to have a label or order details printed or applied to the cup 20. For example, the order may be printed in ink directly on the cup 20 or a label printed and applied to the cup 20 to achieve the same result. Stage 2 may also include moving the receptacle 16 to the dispensing stations 22, 24 in order to add sugar and dairy, if ordered for that cup 20. The receptacle 16 is then moved to the stage 2 end position.

Stage 3 begins by transferring the receptacle 16 from the stage 2 end position and moving the receptacle underneath the dispensing station comprising the set of urns 26 and positioning the cup 20 under the appropriate urn 26. Stage 4 includes dispensing the beverage (e.g., coffee) into the cup 20. At stage 5, the receptacle 16 (or multiple receptacles simultaneously) is picked up from its position below the associated urn 26 (with the type of coffee it has received) and is moved to the associated staging location (e.g., on the far left as shown in FIG. 2b). It can be appreciated that stage 5 may include other steps such as additional additives (honey, chocolate powder, etc.) and may include stirring and lidding operations. The stirring and lidding operations may be done using a separate automated sub-stage and machine (not shown) or by integrating a sub-module or stage into the system as shown herein, e.g., a sub-module which is in a fixed position on the machine or which is placed on an overhead gantry and brought to each cup 20. The operator may then serve the cup 20 by removing it from the receptacle 16 and then return the receptacle 16 in a closed-loop fashion at stage R by placing it in the return ramp 25 to begin stage 1 again. The operator or machine may also be integrated with the environment such that it is automatically placed into an offload area, e.g., with a drive-through or other serving area.

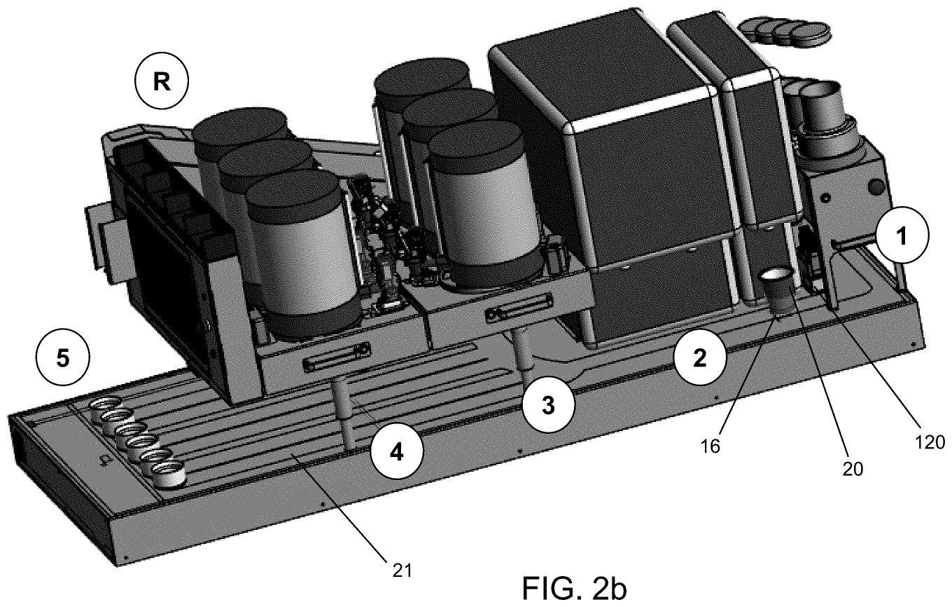

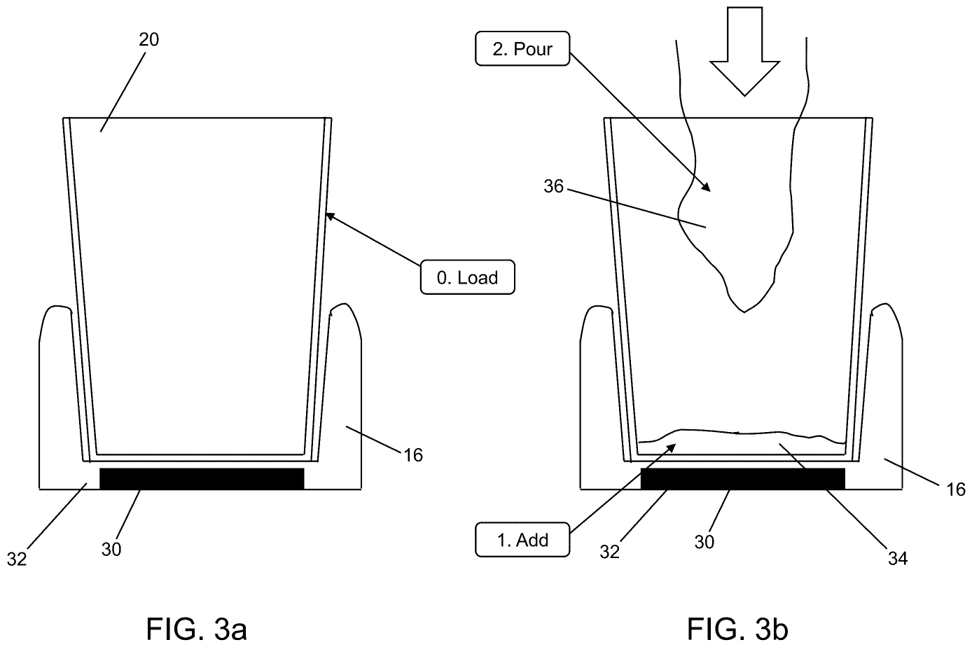

FIGS. 3a and 3b illustrate a cross-section of a cup 20 and a receptacle 16 configured in this example to hold or otherwise support the cup 20 in its interior portion. The receptacle 16 in this example includes a taper along its sidewalls to generally conform with the shape of the cup 20, however, other shapes and contours can be used for handling other types of food products or containers for such food products. As noted above, the term “receptacle” as used herein can be used interchangeably with any object that is adapted and configured to be coupled via magnetic attraction to a magnetic guide 40 (see below) such that it may be moved over the counter surface 14 according to a desired path. The receptacle 16 includes a base 32 with an embedded magnet 30, however, in other embodiments a magnetic material such as a ferrous material may be embedded or otherwise included in the base 32 of the receptacle. It can be appreciated that the base 32 itself can be magnetic or posses a magnetic effect via any other mechanism such as by using a magnetic or ferrous paint or other layer. As such, in general, the receptacle has at least a portion which possesses a magnetic property and can be coupled to another magnetic element via a magnetic force between them. In FIG. 3a step 0 is shown which includes loading the cup 20 into the receptacle. Step 1 shown in FIG. 3b corresponds to the addition of a first substance 34 (e.g., sugar at station 22 and/or dairy at station 24), and step 2 corresponds to the pouring of a second substance 36 to be mixed with the first substance 34 (e.g., coffee at zone 26).

FIGS. 3c, 3d-i, 3d-ii, 3e, and 3f illustrate an example of a configuration for the receptacle 16. In this example, a set of multiple (e.g. 3) feet 39 is spaced about a central drain hole 19 in the base 32 of the receptacle 16. Moreover, the sidewall 21 of the receptacle 16 may include a sloped entry 17 to facilitate loading of the cup 20 into the receptacle 16, e.g., by the cup dropper 18 in FIG. 1b or other cup dispensing mechanism 18 shown in FIG. 1a. A portion of a cross-section of the base 32 and a portion of the floor of the receptacle 16 as encircled in FIG. 3d-i is shown in FIG. 3d-ii. The curved floor 35 of the receptacle may include a cavity 33 into which a protrusion 37 is inserted in a two-piece optional configuration shown in FIGS. 3e and 3f. That is, the base 32 portion may be separable from the main body of the receptacle 16 for maintenance and cleaning purposes, however, such a configuration is optional. It can be appreciated that any number of pieces may be used to construct the receptacle 16 and the two-piece configuration is only one example. As shown in FIG. 3, the receptacle 16 may include a geared profile to permit rotation (e.g., to orient the cup 20) or may include multiple magnets 30 (not shown) and utilize selective magnetic forces to rotate and align the receptacle in a particular orientation.

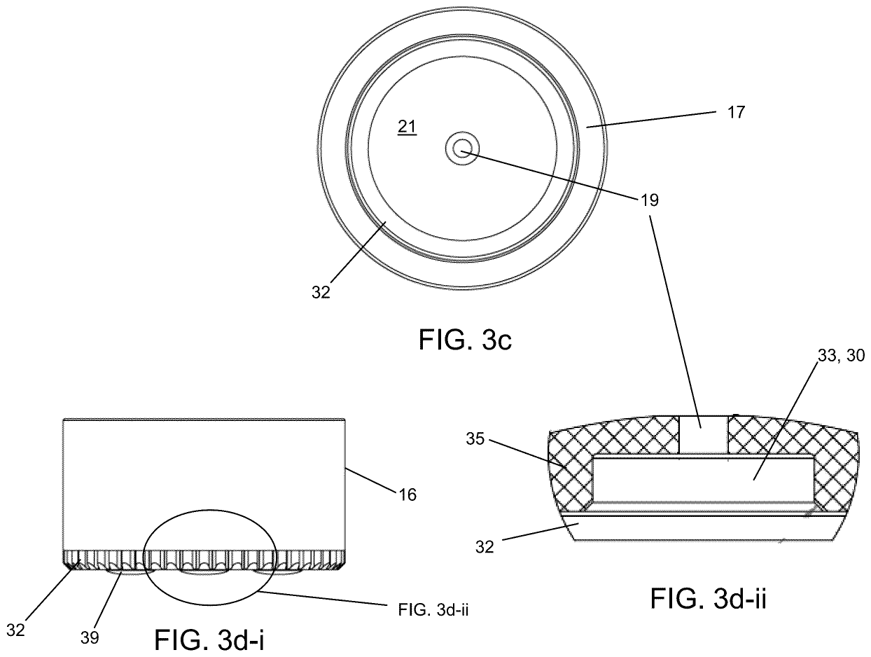

To move the receptacle 16 between different stations such as those shown in FIGS. 2a and 2b, one or more magnetic guides 40 (see FIGS. 4-7) can be positioned beneath the surface 14 and be moveable along one or more path segments to correspondingly move the receptacle 16 on top of the surface 14 through magnetic attraction. Any number of path segments can be used to provide more or less granularity in the overall path or to allow for multiple receptacles 16 to be processed simultaneously. For example, stations 1-5 shown in FIG. 2a can include five separate path segments or as few as two with a single path segment taking the receptacle 16 through stations 1-3 and handing off to a second path segment to align with station 4, then be picked up again along the same first path segment to station 5. Alternatively, a path segment can be used for each span between stations.

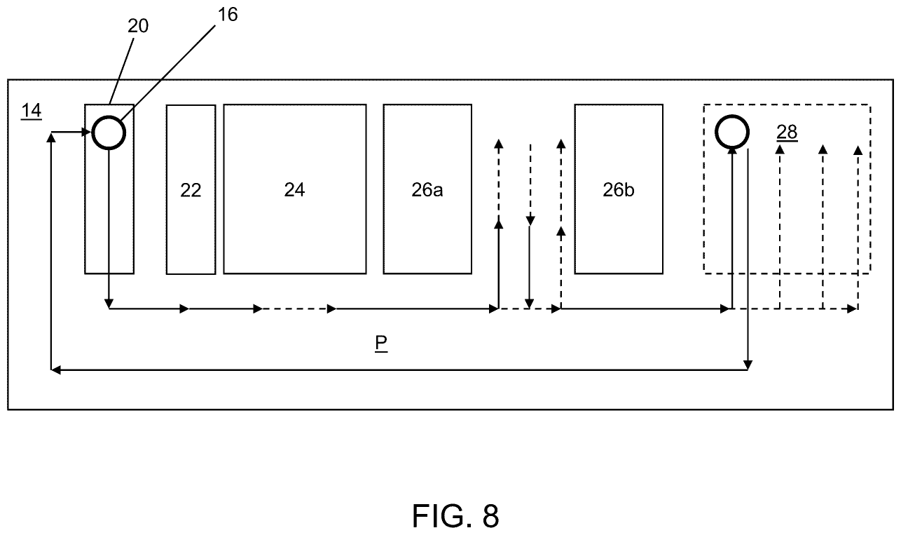

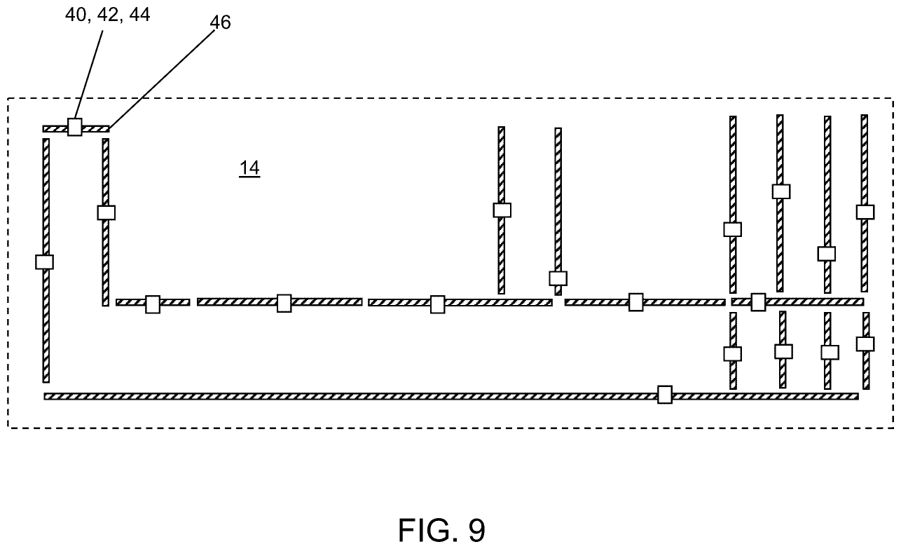

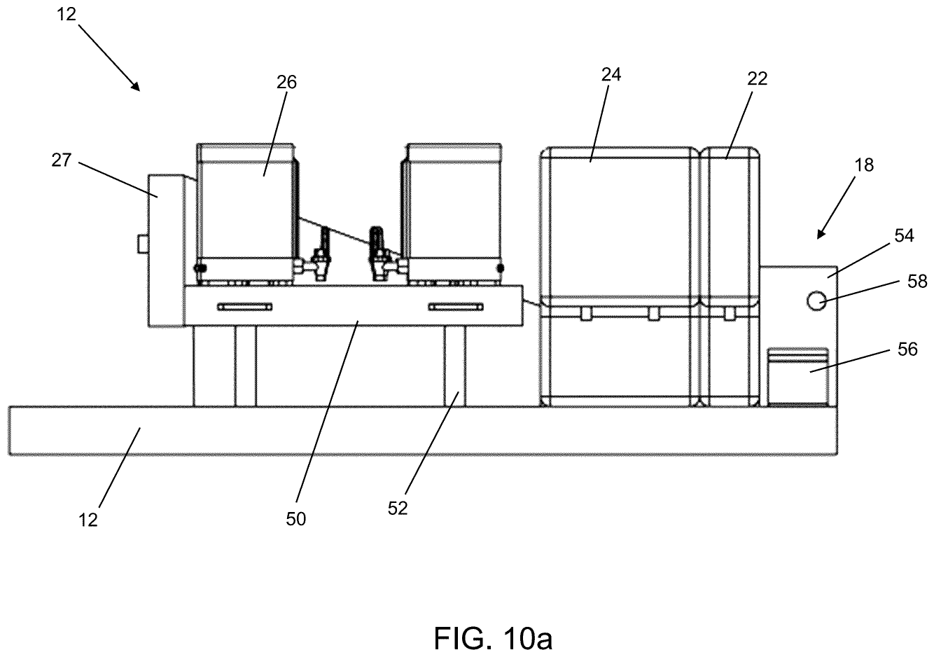

Referring now to FIGS. 4a-4d, an example is shown in which a pair of adjacent and parallel path segments, aligned end-to-end, enable a first magnetic guide 40a (having a first magnet 42a or other magnetic or ferrous material or property) to hand off the receptacle 16 to a second magnetic guide 40b (having a second magnet 42b or other magnetic or ferrous material or property). It can be appreciated that any mechanism capable of selectively applying and removing magnetic attraction can be used, including electromagnets that are activated or deactivated. FIG. 4a illustrates a first stage wherein the first magnetic guide 40a is aligned with the receptacle 16 by advancing a first guide actuator 44a along a first segment path 46a. It can be appreciated that the term “segment path” 46 may refer to any mechanism along which the guide actuator 44 can travel, including, for example, a linear shaft, belt/pully, rack and pinion, cord/cable, slot, articulated arm, etc. The segment path 46 may be a single segment as illustrated in FIG. 4 or may be incorporated into a gantry-like segment 46′, 47 (see FIG. 11 described below). As such, the principles discussed with respect to FIGS. 4-7 below equally apply to the configuration shown in FIG. 1a/2a and 1b/2b. In this example, the actuator 44a contains a linear non-captive nut that travels along a threaded shaft used to provide the first segment path 46a. In alternative embodiments, the described linear drive system can include belt and pulley arrangement, ball screws, lead screws, linear motors, rack and pinion systems, cable drives, and pneumatic or hydraulic cylinders, each offering distinct advantages based on application-specific requirements of precision, load capacity, speed, and environmental compatibility. That is, the first segment path 46a is embodied as a linear screw shaft in this example such that by operating the linear non-captive nut in the first actuator 44a, the actuator 44a and its attached magnetic guide 40a can travel in either direction along the path segment. As shown in FIG. 4a, a second magnetic guide 40b is operable with a second guide actuator 44b to travel along a second segment path 46b to perform a handoff of the receptacle from a first segment of the path to a second segment of the path. FIG. 4b illustrates placement of the receptacle 16 in alignment with a handoff zone or gap (G). It can be appreciated that an overlap may occur in different configurations where a gap G does not exist, e.g., if two parallel but offset segments 46 overlap at the ends with no gap G. In this example, the gap G is sized to permit the first magnetic guide 44a to extend beyond the end of the first segment path 46a and permit the second magnetic guide 44b to advance into the gap G at the same time such that by decoupling the first magnet 42a and coupling the second magnet 42b to the magnet 30, the magnetic attraction is transferred from the first path segment to the second path segment. The first guide actuator 44a may then be instructed to reverse direction along the first segment path 46a while the second guide actuator 44b can advance along the second segment path 46b to move to a next segment or a next station along the same segment. This is illustrated in FIG. 4d. FIG. 4d also illustrates that the receptacle 16 shown in FIG. 4c can be considered a first receptacle 16a that advances along the second segment path 46b while the first magnetic guide 40a is used to pick up a second receptacle 16b and advance it towards the gap G to be handed off to the second magnetic guide 40b to repeat the process shown in FIG. 4.

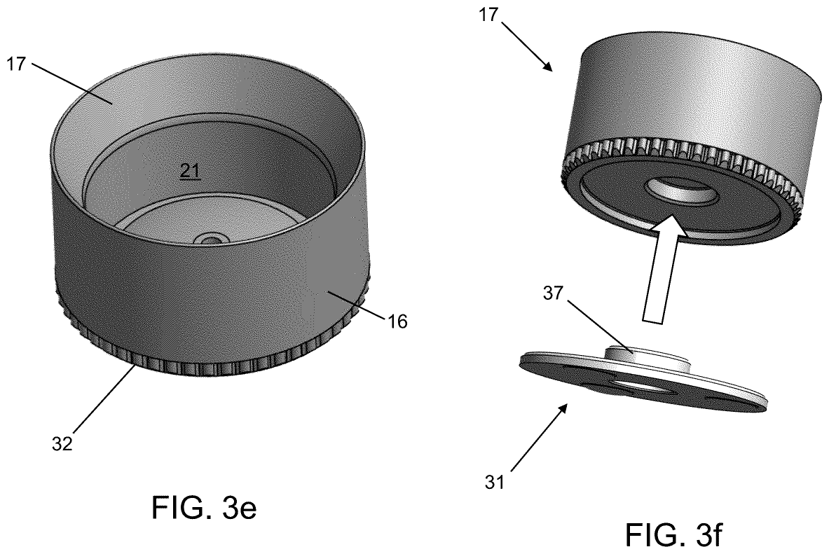

FIGS. 5a-5d illustrate a similar hand off that is executed in a different manner. In this example, the receptacle 16 is aligned with the gap G in FIG. 5a as in FIG. 4. However, the first magnetic guide 40a is decoupled and the first guide actuator 44a instructed to retreat while leaving the receptacle 16 behind to be picked up at a later time by the second magnetic guide 40b. That is, FIGS. 5a and 5b illustrate that different hand off sequences are possible depending on the timing and throughput of the process. For example, the receptacle 16 may be left behind as shown in FIG. 5b to have a station operation applied before being picked up by the second magnetic guide 40b as shown in FIG. 5c. FIG. 5d illustrates that as the first receptacle 16a is advanced along the path using the second segment, the first magnetic guide 40a can retreat to pick up the second receptacle 16b as was shown in FIG. 4.

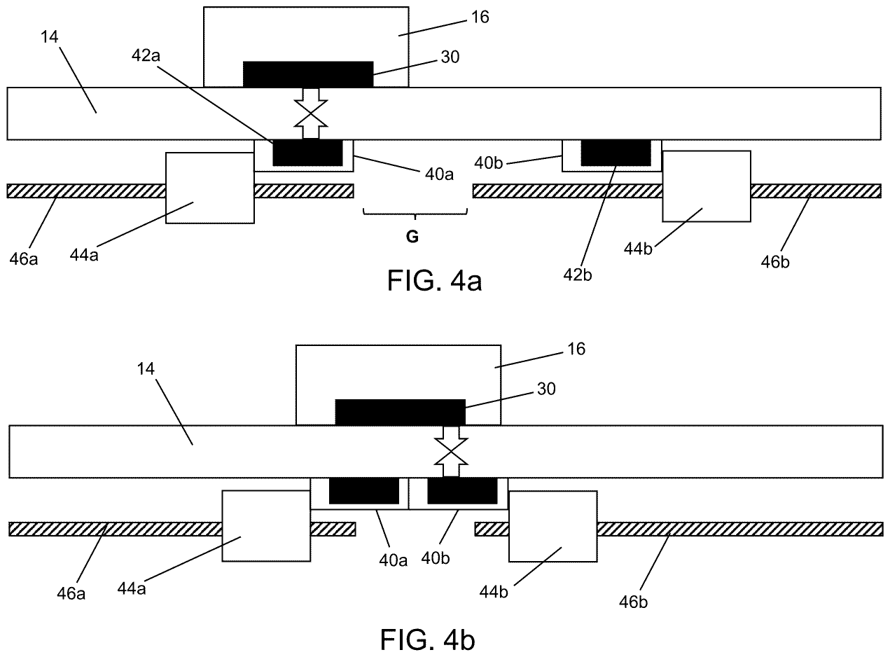

FIGS. 6a-6d illustrate a hand off between non-parallel segment paths 46, in this case a first segment path 46a which is substantially perpendicular relative to a second segment path 46b. As with FIGS. 4 and 5, the first guide actuator 44a can advance along the first segment path 46a to place the first magnetic guide 40a within a handoff zone or gap G. The second magnetic guide 40b is then moved into aligned within the handoff zone to pick up the receptacle 16 and move it perpendicular along the next path segment as shown in FIG. 6c, wherein the receptacle 16 moves laterally relative to the first path segment. It can be appreciated that while the examples shown in FIGS. 5 and 6 illustrate end-to-end and perpendicularly oriented segment paths 46, the same principles can apply to segment paths 46 that are oriented at any angle or position relative to each other so long as the magnetic guides 40 can reach the gap G and be able to couple or decouple the receptacle magnetically.

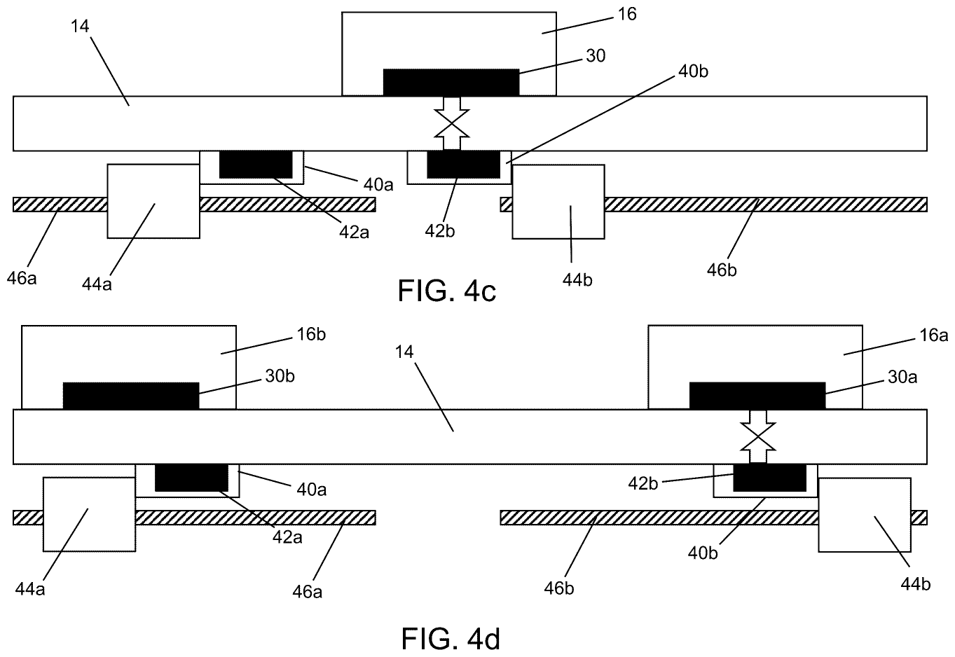

As shown in FIG. 7, the gap G can vary and by placing the magnetic guide 40 above the guide actuator 42, a smaller gap G can be used. In this example, with a smaller gap G, the two magnetic guides 40a, 40b are used in succession rather than being located in the gap G at the same time. That is, various configurations are possible according to the path desired and the application to which the magnetic guides 40 are applied. For example, if the gap G aligns with a filling station, the first magnetic guide 40a can “drop” the receptacle 16 at the filling station and retreat back along the segment path 46a to pick up the next receptacle 16 while the second magnetic guide 40b moves in to pick up the receptacle 16 when the filling operation is finished. As such, various sequences are possible to accommodate the preparation line, the current order, and various other factors. It can be appreciated that while examples provided herein illustrate one guide actuator 42 and magnetic guide 40 per segment path 46, as indicated above, more than one guide actuator 42 can be accommodated on a single segment path 46. For example, multiple guide actuators 42 may be moving and operating on one segment path 46, with each actuator 42 being controlled independently of one another while sharing the same segment path 46.

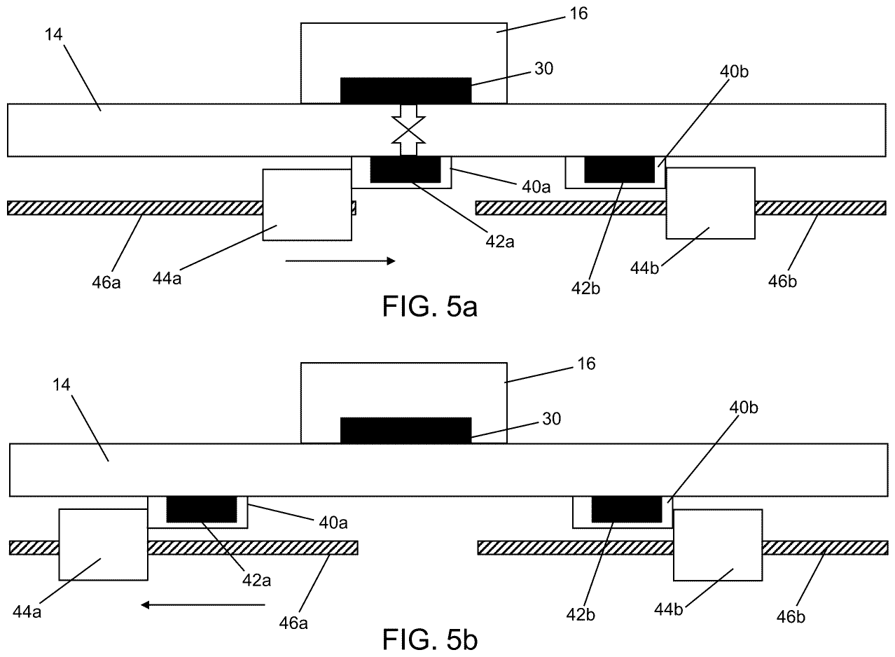

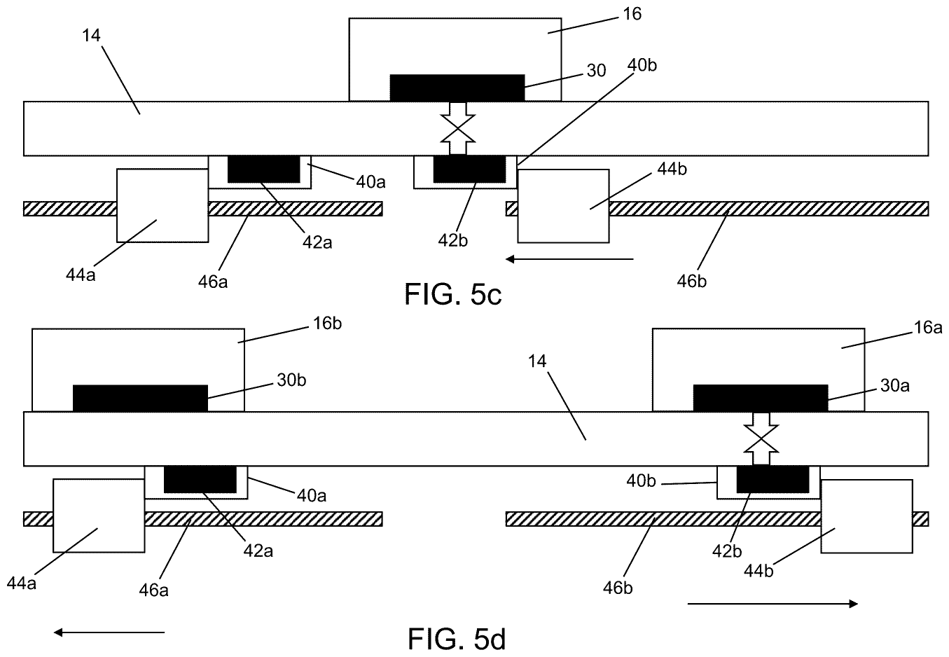

FIG. 8 illustrates an example of a path P that can be used to implement the beverage preparation line 12 shown in FIG. 2a. It can be appreciated that the path P may be adapted to any application and may include any one or more segments 46. That is, the path P may include multiple different segments 46 as shown in FIG. 8 or have as few as a single fixed segment 46 that moves an item linearly therealong and the principles discussed herein and the system described equally apply to any one or more segments of a path P. Here, the path P is divided into a number of segments, each denoted using a separate arrow (with arrowhead to denote direction). The receptacle 20 advances along a number of segments to align with stations 20, 22, and 24. While separate segments are shown between stations 22, 24, and 26a, it can be appreciated that the same magnetic guide 40 could instead be placed at different spots along the same segment shaft 46 as indicated above. Here, a separate magnetic guide 40 and guide actuator 44 is used on each segment path 46 as shown in FIG. 9, which illustrates a layout of segment paths 26 to collectively provide an overall path P. At stations 26a and 26b, lateral or perpendicular path segments are used to slide the receptacle 16 into a desired filling/pouring zone and then back onto the main path artery towards the pick up zone 28. Here, a number of lateral path segments are used to fill multiple pick up lanes. For example, each lane could be associated with an order number, a product type or some other designation. The segment paths 46 shown in FIG. 9 would be mounted beneath the surface 14 in a layout that mimics the desired path P for the receptacle 16 atop the surface 14. The individual guide motors 44 can be programmed to advance and retreat as well as couple and decouple the magnets 42 (or other magnetic or ferrous material) to drop off, pick up and/or handoff the receptacle 16 to complete the desired path. It can be appreciated that the path can also vary using the same set of path segments. For example, if a coffee is ordered “black”, stations 22 and 24 can be bypassed by performing successive handoffs without requiring pauses to perform the corresponding station operations. As indicated above, the handoff zones do not need to be parallel or perpendicular to each other and other orientations are possible depending on the desired path P.

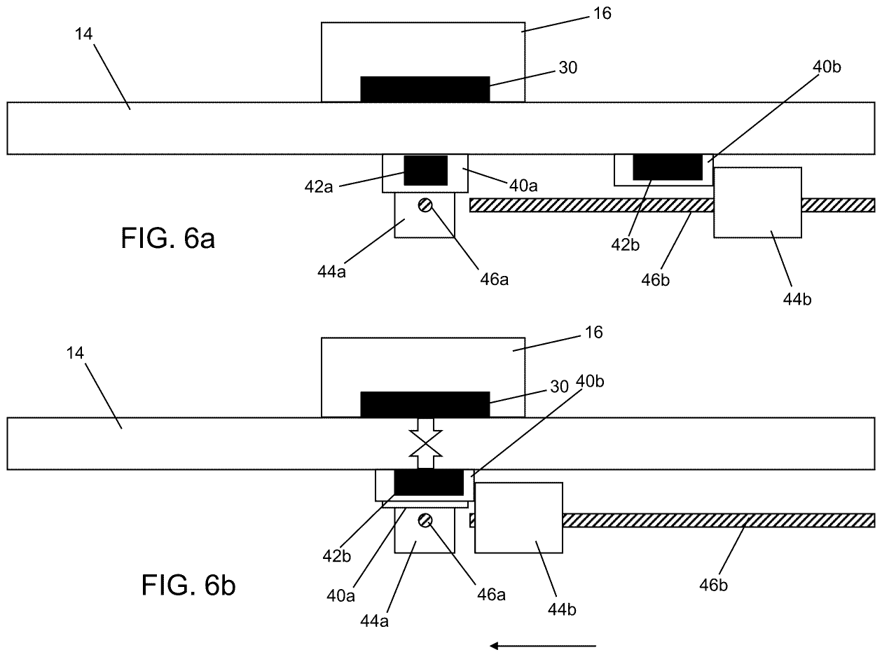

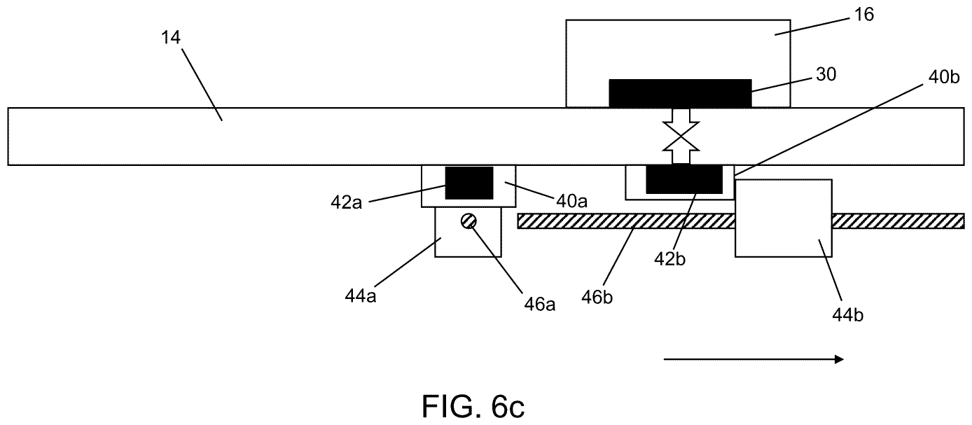

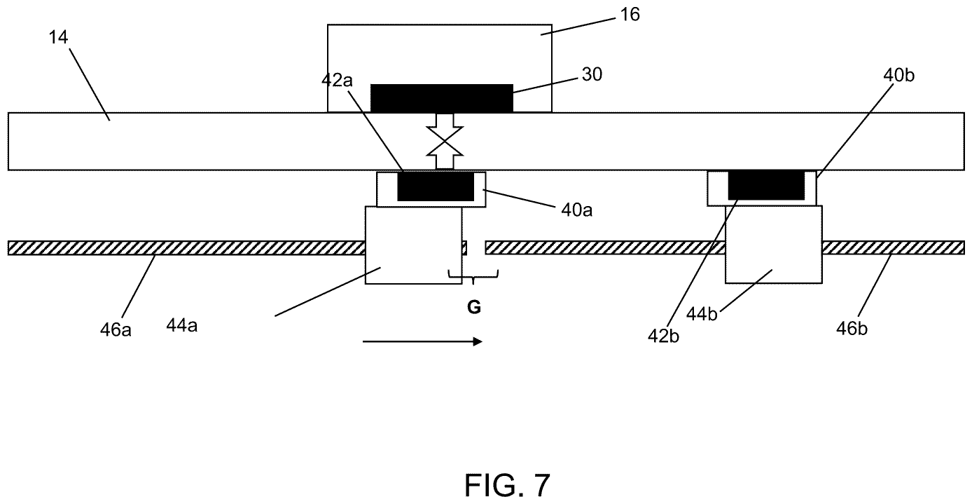

Referring now to FIGS. 10a, 10b, and 10c, the layout of the line 12 shown in FIGS. 1b and 2b is shown. In the elevation view of FIG. 10a an urn shelf 50 is raised above the surface 14 using a set of supports 52. This increases the surface area of the surface 14 that is available to the system for moving the receptacles 16 into and out of positions for filling at the urns 26. Moreover, the shelf 50 itself may be slidable atop its frame to permit the shelf 50 to be pulled towards a user (like a drawer) to facilitate removal of an urn 26 situated on that shelf 50. It can be appreciated that one or more shelves 50 may be used such that all urns 26 may be pulled outwardly in unison, or a selected number (e.g., half on one shelf 50 and half on the other). Moreover, in the configuration shown in FIG. 10a, shelves 50 may be provided on both sides of the system. That is, various configurations are possible. In the configuration shown, the receptacle 16 may begin by being loaded or placed under the stepped frame 54 of the cup dropper 18 and move through a passage 56 beneath the cup dropping zones. The cup dropper 18 may include a pause switch 58 to enable the line movements to be halted, for example, to permit a backlog of ready orders at the delivery end of the line 12 to be served or to otherwise allow a remediation or catch up operation to be performed by intervening in the progression. After moving through the passage 56, with a cup 20 having been loaded, the receptacle may then move to the dispensing stations 22, 24 and then to the pouring zone that includes the urns 26, but travelling beneath the urn shelf 50 to an appropriate urn 26. The urns 26 may each contain a different type of coffee (or other beverage) to be poured (e.g., regular roast, dark roast, decaf) and some urns 26 may contain the same beverage, e.g., for higher volume types such as a regular roast rather than a decaf.

It can be appreciated that the drive system beneath the surface 14 may operate according to the principles discussed above, to permit the receptacles 16 to be moved to be in alignment with any one of the urns 26 and multiple receptacle 16 can be placed in the pouring zone, i.e., where multiple cups 20 are waiting to be filled or waiting to move to the next step in the progression, according to the timing of the orders, the throughput at the delivery end, etc. The delivery end beyond the user interface module 27 is best shown in FIG. 10b, which includes an area to position the receptacles 16 while the cup 20 being held thereby is waiting to be served, after which, the receptacle 16 can be placed into the return ramp 25 to be reused at the cup dropper 18.

The cup dropper 18 is shown in elevation in FIG. 10c, which includes four steps, namely 54a, 54b, 54c, and 54d, each corresponding to a cup size to permit enough head space to accommodate the respective height of the cup 20. The higher the step 54, corresponds to a higher cup 20. For example, step 54d may be used for extra-large cups 20 while step 54a may be used for small cups 20.

A drive system is shown in FIG. 11a, which is suitable for the configuration shown in FIGS. 1b, 2b, and 10a-10c. The path P in this configuration is best seen in the plan view of FIG. 11b. In this configuration, a transverse path segment 46i is provided along with a main longitudinal path segment 46ii, each having one or more actuators 44 that can move therealong to move a receptable 16 along the surface 14 as discussed above. In addition to fixed path segments 46i, ii, movable gantries 46′, 47 are also provided, which move one or more actuators 44 longitudinally and, in the case of gantry 46′ in x and y directions, to enable multiple receptacles 16 and cups 20 to be placed under the urn shelves 50 to permit concurrent and/or simultaneous dispensing to increase throughput. The gantry 46′ shown in FIG. 11b is movable both transversely and longitudinally such that the actuator 44′ can be moved along two axes. In this way, curved and other non-linear movements can be imparted on the cup 20, e.g., as shown in the track lines 21 in FIG. 2b. In operation, the transverse path segment 46i is used to move the receptacle 16 through stage 1 and hands off to path segment 46ii for stage 2 to move through labelling and dispensing operations. The segment 46ii then hands off to the gantry 46′ to move the receptacle 16 in either linear or curved paths as needed to position the receptacle 16 beneath the correct urn 26 for that order. The gantry 46′ can load a cup 20 for each urn 26 (e.g., six in this example) and the gantry 47 can include multiple actuators 44 (e.g., six—one for each urn 26) that can move in unison to pick up all of the receptacles 16 beneath the urns 26. In this way, an order can include up to six cups 20 at once (or more in other configurations) that can be moved to the delivery stage 5. The gantry 47 may be moveable in only one direction as shown, or may include transverse movements of the actuators 44 in other configurations to permit more complicated pickup movements.

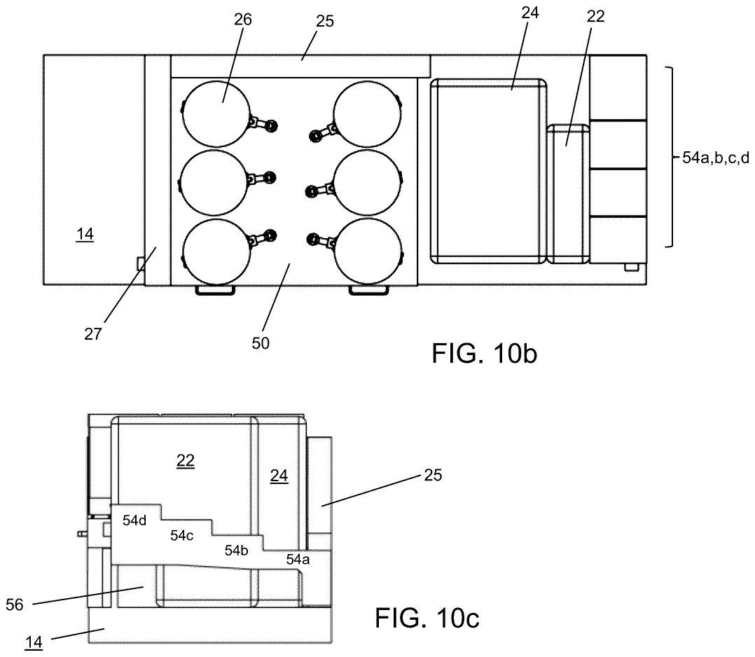

An example of a guide actuator 44 that may be carried along a path segment 46 is shown in FIG. 12. The actuator 44 includes a body 70 that supports a block 72 with a port for a magnet 74 into which a magnet can be placed. In this way, a drive gear 76 can interact with a rack on the block 72to raise or lower the magnet 74 towards and away from the magnet(s) on the underside of the receptacle 16. The gear 76 is driven by a drive motor 78 (e.g., RC or stepper motor), which in this example is connected to the system via a data and power port 80. It can be appreciated that the gear 76 and block 72 is only one example of an actuation mechanism to move the magnet 74 towards/away or to otherwise engage or disengage a magnetic attractive foce from the receptacle 16 on the surface 14, e.g., a pneumatic actuator, electromagnet, etc. The mechanism described herein can be driven by various types of motors. While an RC (Radio-Controlled) servo motor or a stepper motor is the primary driver in the illustrated embodiment, alternative motor options include brushed and brushless DC motors, induction and synchronous AC motors, linear actuators, pneumatic and hydraulic motors, and piezoelectric motors. This versatility allows for optimization based on specific performance criteria, environmental conditions, and cost considerations.

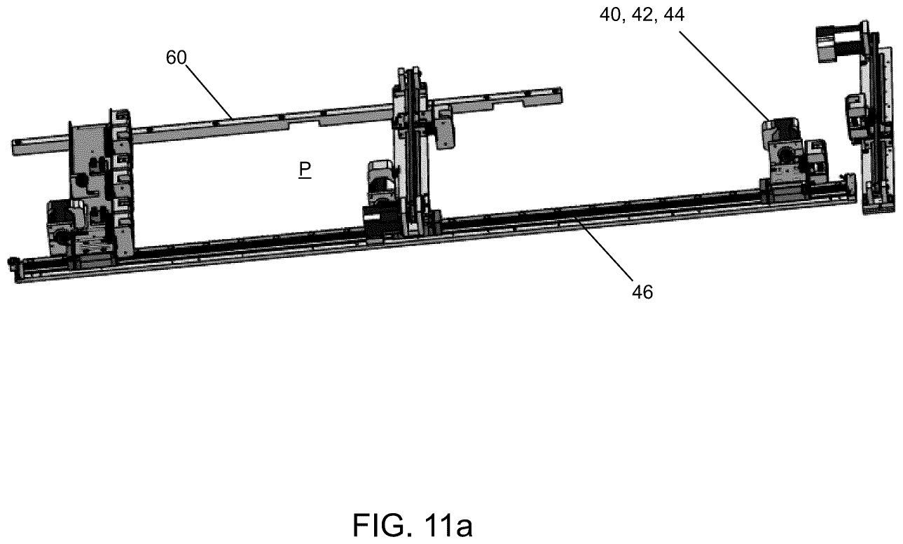

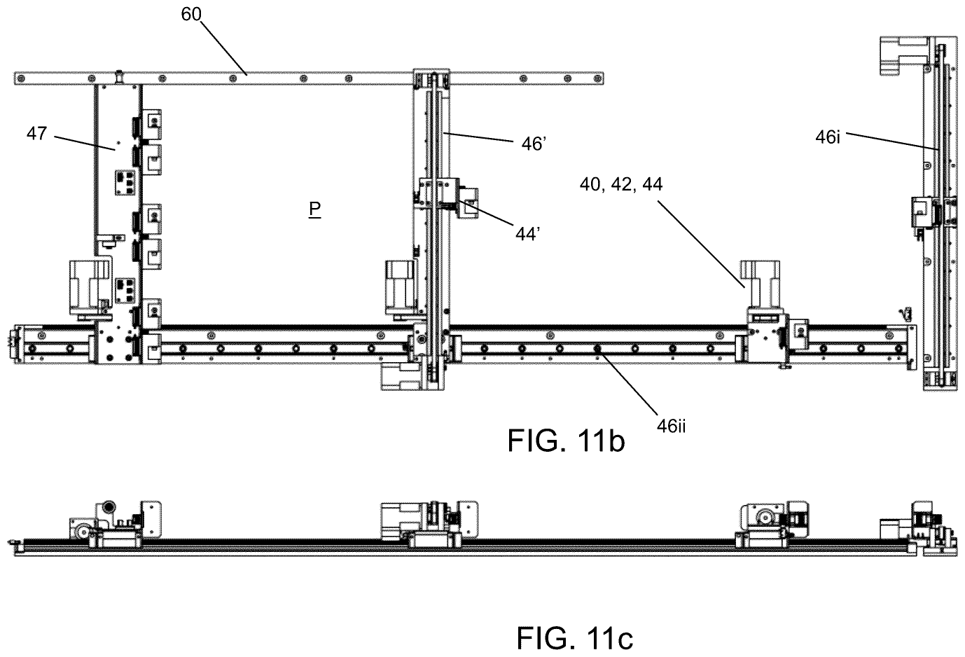

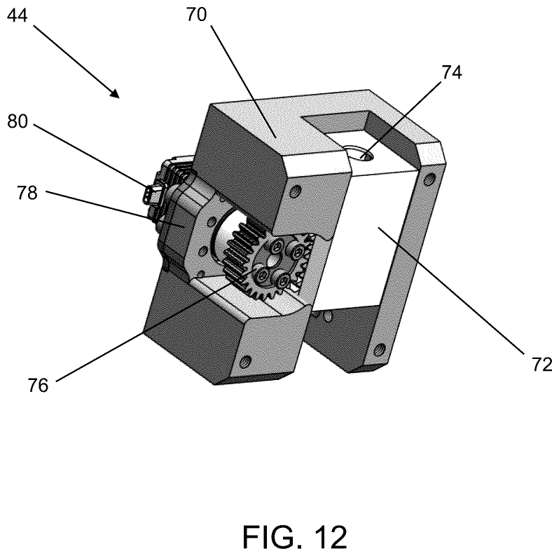

Referring now to FIGS. 13a, 13b, and 13c, a pair of urn shelves 50 is shown, each supporting a set of three urns 26. The urns 26 are connected to power modules 90 to power a heater in each urn 26. Each urn 26 includes a dispensing valve or spout mechanism that may be automatically operated by the system using an urn valve actuator 92. As illustrated in the plan view of FIG. 13b, each urn 26 includes a valve actuator 92, which operates the urn's valve and directs the beverage downwardly towards a cup 20 that is positioned beneath the urn 26 after being positioned atop the surface 14 by the control system and by following the defined path. It can be appreciated that dispensing can be done in various ways. For example, the system can be configured to replace the existing valve with a flow meter for precise dispensing control. Alternatively, load cells can be used, which measure the weight of the urns 26, thus dictating the flow. Load cells can be placed in the receptacles themselves to measure weight of the liquid dispensed. This determines how long the actuator 92 should press and actuate the flow. In other examples, the system may incorporate ultrasonic sensors (e.g., in conjunction with, or to replace load cells) which measure the height of the liquid in the cup 20 and thus signal the valve actuator 92 when to stop pouring. The liquid height measurement can be performed using an ultrasonic sensor or any other suitable sensing technology capable of determining liquid levels, including but not limited to capacitive sensors, optical sensors, radar sensors, and pressure sensors.

The urn shelves 50 and supports are best seen in FIG. 13c, illustrating the area beneath the valve actuators 92 to permit a cup 20 to be positioned under a specific urn 26 by a receptacle 16 according to an order that has been placed. The urns 26 may be connected to the system to share sensor data and allow for certain urn optimizations. For example, the urn 26 may be tagged, e.g., using RFID or any other communication protocol, to allow multiple urns 26 with the same beverage to be prioritized based on when the contents of the urn 26 was brewed, the fill level, etc. The urn 26 may be selected first based on time of brewing (oldest first) and then by which has the most product remaining (fill level). There may be two decision points for allocation, first when the order is taken in from the queue and then just after the additives have been dispensed but before moving the cup 20 under the shelves 50. Pausing the system (e.g., using a pause button) may allow the mechanisms to move to a safe state between motions and then disable mechanisms for quick manual intervention such as a free pour or manual addition of additives. Using a convenience stop, all automation mechanisms would be disabled and the components mounted on the system can be used as normal until a full system homing sequence is completed. When the shelves 50 are paused in either case, tabletop markings and detents can be used to allow the operator to line up a cup for a free pour.

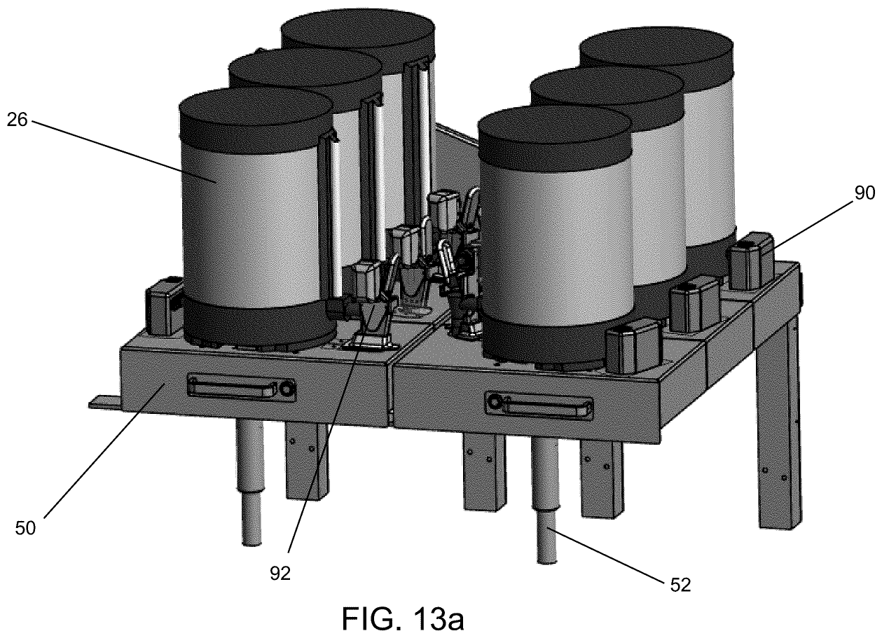

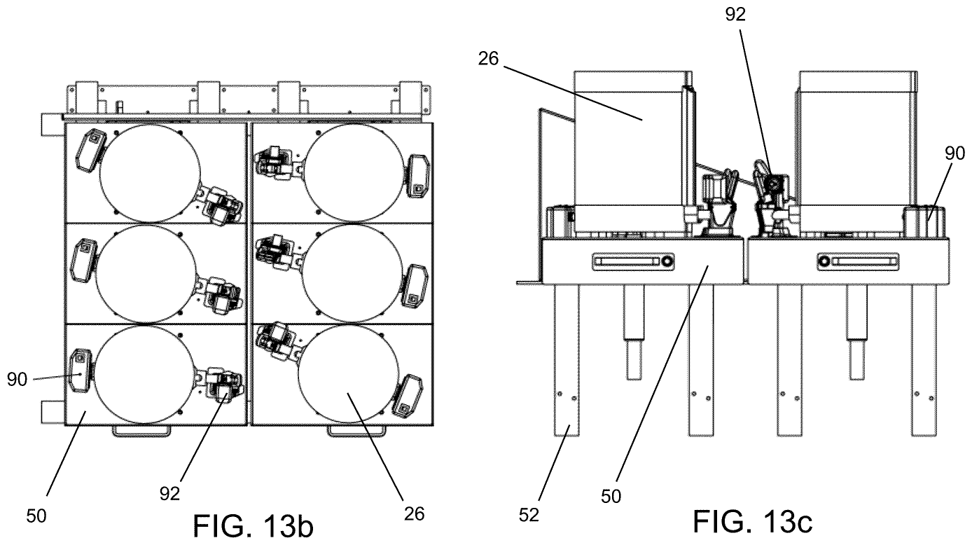

The valve actuator 92 is shown in greater detail in FIGS. 14a, 14b, 14c, and 14d. Each valve actuator 92 includes an actuator arm 94 that is controlled by a servo or other motor 96. The motor 96 and arm 94 are supported on a valve collar 98, which is contoured to connect or couple to the valve of an urn 26. The valve collar 98 may also have, at it distal end, an adapter plug 100 with a set of ports into which a complementary set of pins in a mating unit on the shelf 50 fit to deliver power to the actuator 92. The actuator 92 thus operates the arm 94 to control the existing valve on the urn 26 to dispense beverage through a passage in the shelf 50 to ensure the liquid passes downwardly into a cup 20 positioned on the surface 14 beneath the corresponding urn 26.

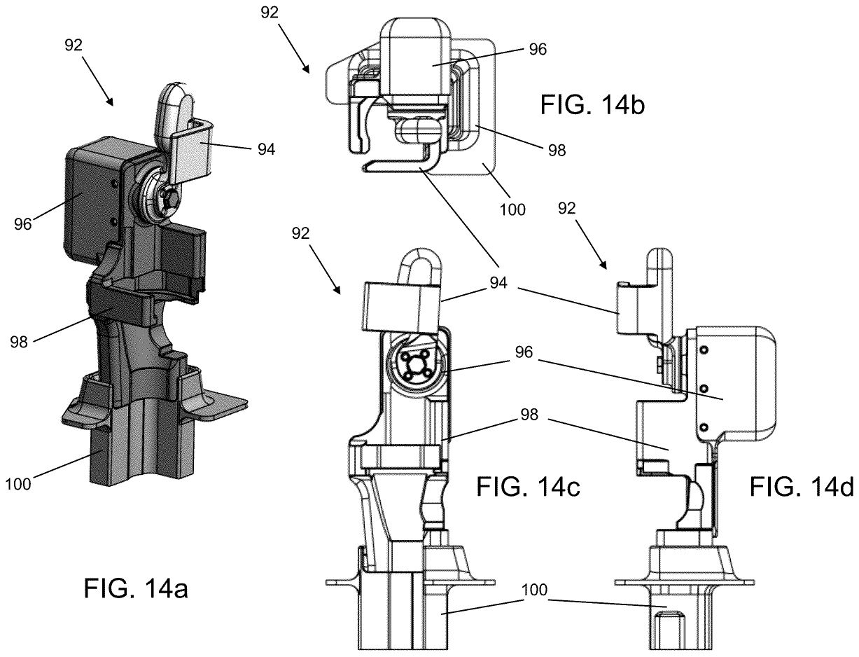

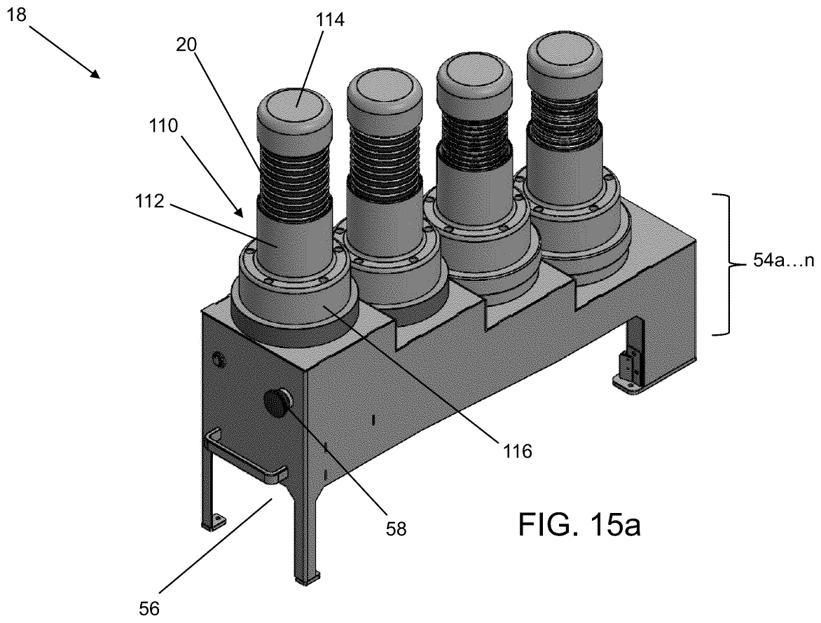

The cup dropper 18, in the configuration shown in FIGS. 1b and 2b, is shown in greater detail in FIGS. 15a, 15b, 15c, and 15d. The cup dropper 18 in this configuration includes a stepped frame 54, with a step 54a, 54b, 54c, and 54d for each corresponding cup size as noted above. The frame 54 may have various different layouts and the linear stepped configuration is only one example. For example an “L” shaped layout may be used or an “index ring” where the receptacle 16 goes to the same position and the ring is indexed to bring the appropriate cup 20 to that receptacle 16. As can be seen in FIGS. 15a and 15c, the stepped configuration provides differing heights beneath each cup canister 110 to accommodate the different heights in the cups 20. Each cup canister 110 includes a cup receptacle 112 into which the corresponding cups are stacked and loaded, a base connector 116 to permit attachment to the corresponding step 54x of the frame 54, and a dust cap 114 to enclose the cups 20 in the canister 110. The canister 110 may include an actuation mechanism to release a cup, such as a cam or claw to grab the next cup. Referring to FIG. 15c, the frame 54 may support a vision camera 118 for imaging cups 20. For example, the cup 20 may be imaged to find a blank spot onto which a label can be printed by the inkjet printer module 120. The receptacle 16 may be rotated (e.g., using the geared base 32 or by activating selective ones of a set of magnets to align with the orientation of the inkjet printer module 120 or other labelling mechanism used. A beam break 120 may be provided to detect the presence or absence of a receptacle 16 prior to dropping the cup 20.

FIGS. 16a, 16b, 16c, and 16d illustrate details of the inkjet printer module 120 which is used in this example for the labelling portion of stage 2 shown in FIG. 2b. The module 120 includes an inkjet printer 122 into which an ink cartridge 124 is inserted. The printer 122 is supported by a body 126, which sits atop a base 128. A gear 130 is used to move the module 120 along a track and the gear 130 protrudes from the base 128 as best seen in FIGS. 16a and 16d. The inkjet printing functionality is only one example and, as discussed herein, a label may be applied to the cup 20 or the cup 20 may be engraved with CO₂, or fiber optic laser etching, etc. A beam break 132 is provided for ensuring that a cup 20 is present prior to activating the inkjet printer module 120.

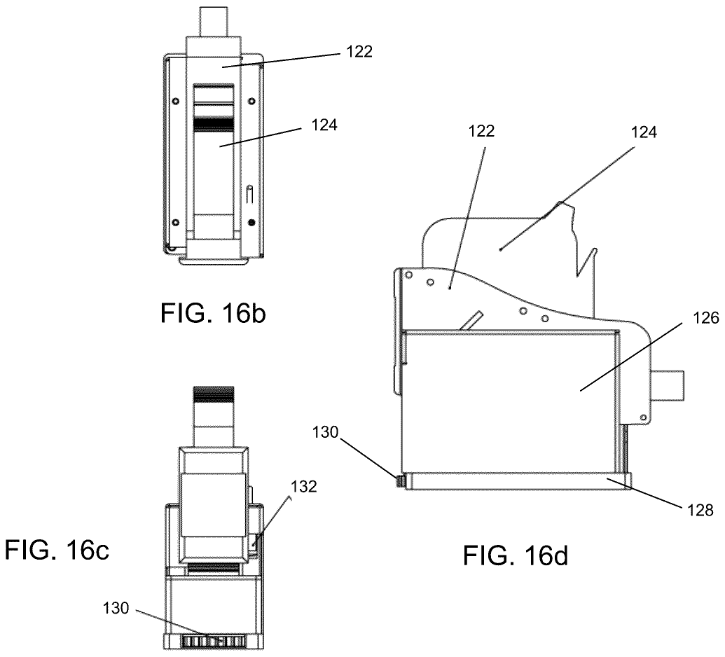

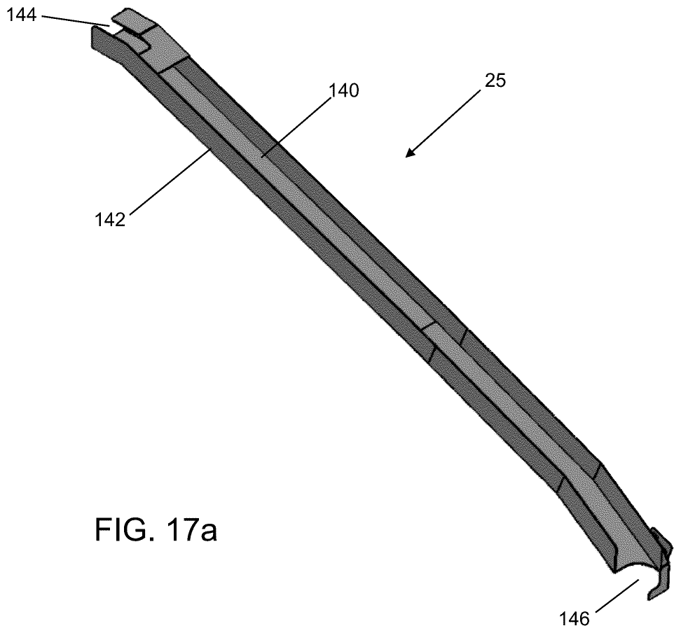

FIGS. 17a, 17b, and 17c illustrate the return ramp 25 in isolation and in greater detail. The ramp 25 includes a floor 140 with a pair of upstanding walls 142 to guide a receptacle 16 from an entry slot 144 to an exit point 146. The ramp 25 may include an additional force imparted to guide the receptacle 16, e.g., rollers, blower, etc. That is, the user can insert the receptacle into the entry slot 144 and push or slide it gently into the main body to slide along the floor 140, constrained by the walls 142, towards the exit point 146, where it can be picked up by the linear drive system below the surface 14 to move the receptacle 16 int the passage 56 of the cup dropper 18 to receive a cup 20 for a next scheduled order. In this way, the return ramp 25 provides a controlled return loop for the receptacle 16 for continuous reuse. It can be appreciated that the shape, slope, size and configuration of the return ramp 25 can vary based on the constraints of the overall system and it configuration. However, by having a certain amount of slope, the receptacle can return to the exit point 146 without requiring additional motive power. The floor 140 of the ramp 25 can have a suitably low friction surface, which may be inherent to the material used or added by way of a coating or treatment.

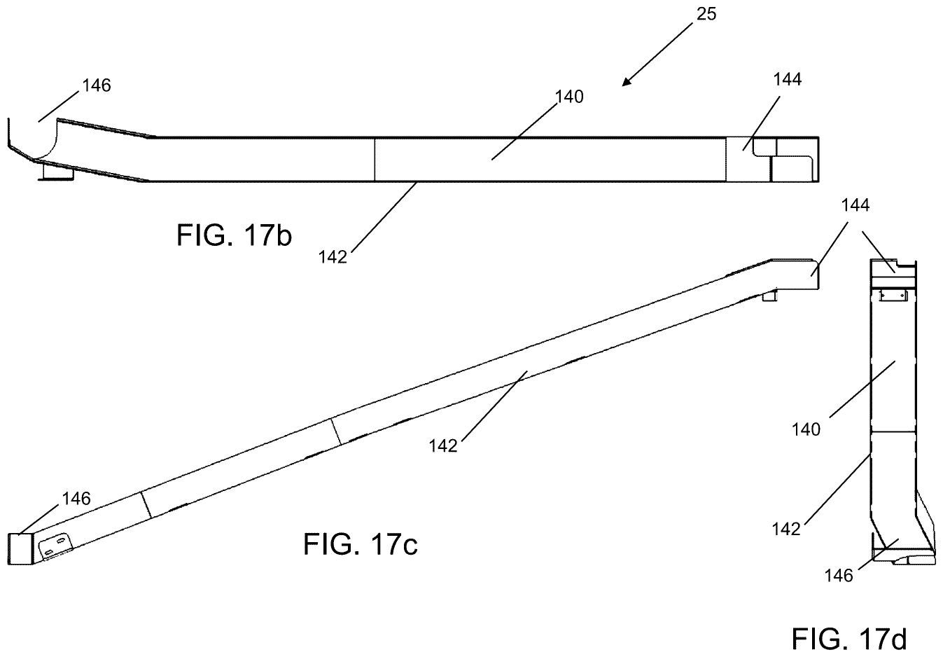

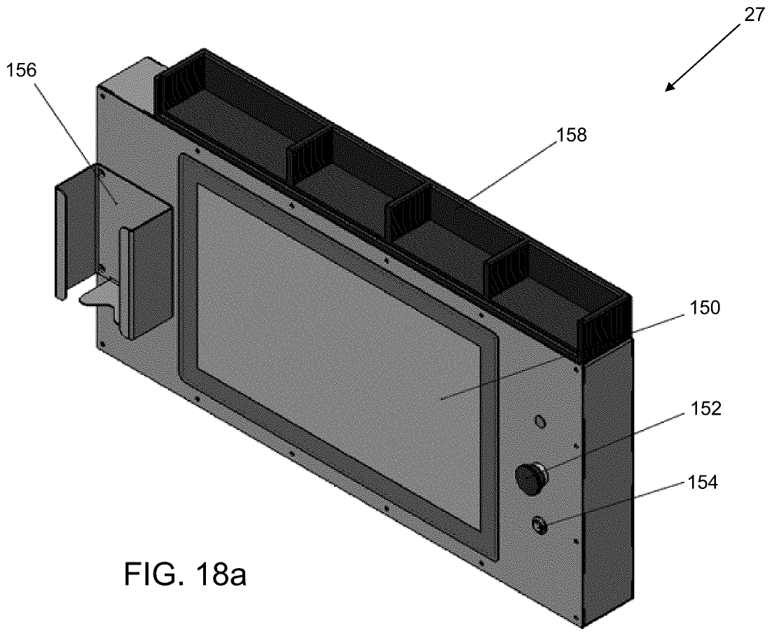

The user interface module 27 is shown in greater detail in isolation in FIGS. 18a, 18b, 18c, and 18d. The user interface module 27 may be mounted as shown in FIGS. 1b and 2b or at another location depending on the workflow of the establishment utilizing the system. The module 27 can be used to provide a user interface display or screen 150 and manual controls such as a stop button 152 and an order call button 154. The housing for the screen 150 can also be used to support other accessories, such as a sleeve holder 156, used to store sleeves that may be selectively added to a cup 20 before presenting the cup 20 to the customer; and an additives tray 158 used to hold other items such as spout stoppers, stickers, honey, sweeteners, stirring sticks, napkins, etc.

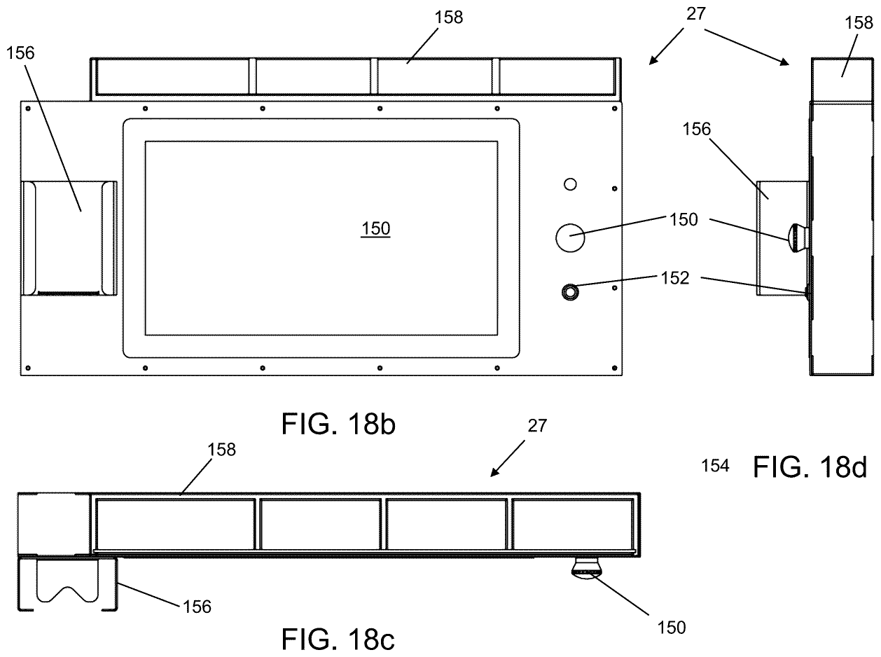

The path P and path segments are controlled by a computing system 200 in order to advance and retreat the guide actuators 44 along the segment paths 46 according to a preparation sequence. An example of a computing system 200 is shown in FIG. 19. The computing system 200 includes a main controller 202 that is coupled to dispensing devices 204 (e.g., preparation station equipment 20, 22, 24, 26 shown in FIGS. 2a and 2b) and to the magnetic guides 40 and guide actuators 44 in each path segment. The main controller 202 can take receptacle data 206 such as an ID for the receptacle and tie that data 206 to an ordering sequence 208 generated by an ordering system, or POS, or human-machine interface such as a control pad operated by a user. In this way, the main controller 202 can generate logic and instructions to move the receptacles 16 along the path segments and to the corresponding dispensing devices 204 to complete an order according to the designated ordering sequence 208 and/or in the most efficient way possible. It may be noted that the computing system 200 may also include sensors or other input devices that permit manual intervention, for example, via a light curtain that senses a human hand entering a zone containing the path P (e.g., for cleaning, spill mitigation, human intervention, etc.), and vision systems to detect spills or other abnormalities such as when cups 20 become stuck, etc.

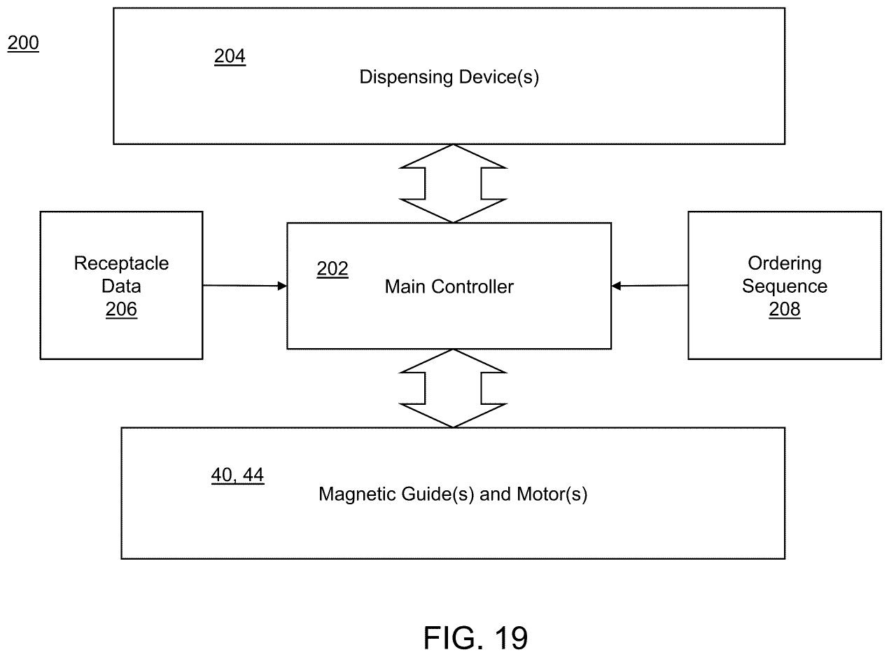

FIG. 20 provides a flow chart illustrating such operations according to the example provided above. It can be appreciated that other operation stations, including lidding, stirring, etc. may be integrated into the operations described herein according to the principles described herein. At step 300 the controller 202 receives the order, which may be a first or next order. For example, the controller 202 may be instructed to prepare a large coffee with two sugar and two milk. At step 302, the controller 202 prepares a path by determining the order parameters and creates a sequence based on the order parameters at step 304. For example, the large coffee would require aligning with a sleeve of large cups and then alignment with both the sugar and milk dispensers prior to coffee being poured. If different types of coffee are available, e.g., regular versus dark roast, this parameter would also be specified and factored into the order sequence and corresponding path. At step 306, the receptacle 16 is positioned along or at a first segment of the path. This may include picking up the receptacle 16 and moving it to the first segment, e.g., by picking up one that is available post order fulfillment. At step 308, the controller 202 determines if the next stop is a handoff zone or a dispensing/operation station. If the next stop is a handoff, at step 310, the receptacle 16 is advanced by the corresponding guide actuator 44 towards the next segment, e.g., to be dropped or handed off in the gap G as illustrated above. The next guide actuator 44 then picks up the receptacle through magnetic coupling as illustrated herein and continues along the segment path 46 and corresponding path segment on the counter surface 14.

If the next step at step 308 is a dispensing station, the guide actuator 44 can position the receptacle 16 at the dispensing station and activate the dispensing operation or wait until it receives a feedback signal that it has been completed. It can be appreciated that steps 310 and 312 may be performed concurrently, wherein the handoff places the receptacle 16 at the dispensing station before being picked up by the next guide actuator 44. At step 314 the controller 202 determines if the order sequence and corresponding path are done. If not, steps 308-312 can be repeated. If so, control can return to step 300 for the next order. It can be appreciated that while FIG. 20 illustrates dispensing stations with dispensing operations, this is only to illustrate one example. For example, the system described herein can be adapted to any food or beverage preparation, for example, sandwich/hamburger assembly, ingredient mixing, toasting/cooking/heating, or any other preparation or assembly process that includes multiple stations positioned at different points along some path P.

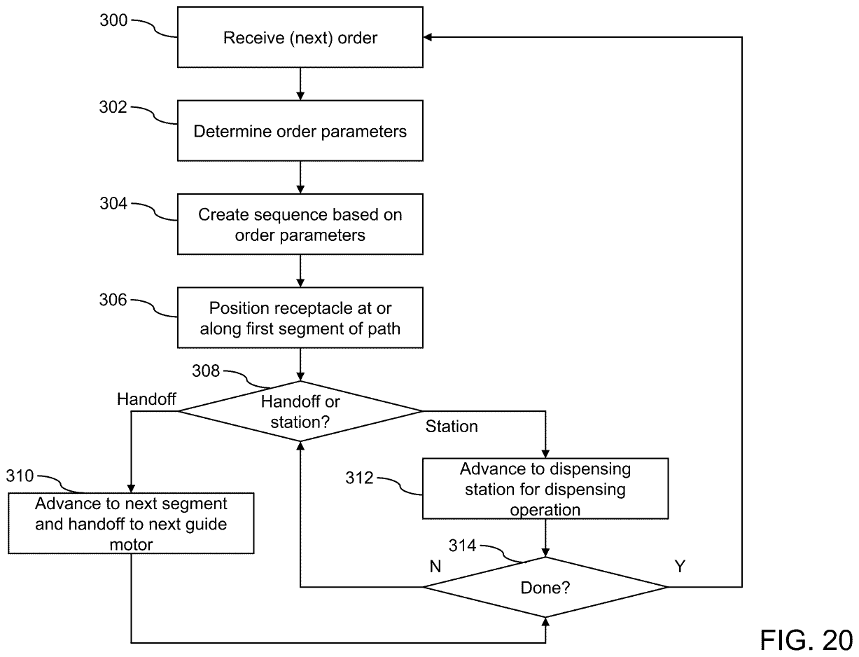

FIG. 21 illustrates example operations that may be performed in executing a hand off process. At step 320, the controller 202 instructs the guide actuator 44 that is in the process of moving the receptacle 16 to advance along the segment path 46 to one end. At this position, the controller 202 instructs the magnetic guide 40 at step 322 to decouple the magnet 42 from magnet 30 to leave the receptacle 16 in place. At step 324, the guide actuator 44 is instructed to move away from the pick up zone (e.g., gap G) and at step 326, the adjacent guide actuator 44 is instructed to advance toward the pick up zone. At this position, the controller 202 can instruct the magnetic guide 40 at step 328 to couple its magnet 42 to magnet 30 and pick up the receptacle 16 for the next segment, e.g., as shown in FIGS. 4 and 5. It can be appreciated that, when the gap G is large enough, steps 322, 324, and 326 can be performed at or near the same time without the need to retreat the first magnetic actuator 44 in order to move in the adjacent one.

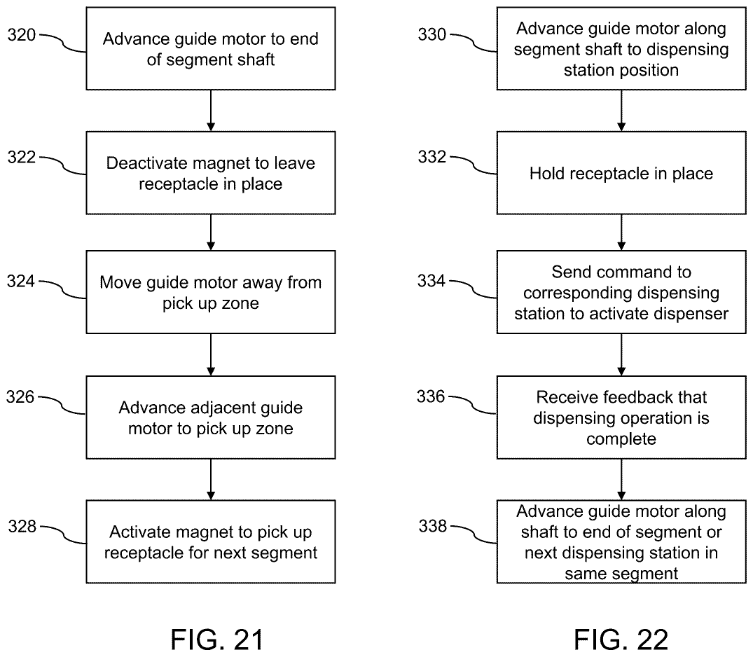

FIG. 22 illustrates example operations that may be performed in activating a dispensing (as in this example) or other preparation station at some point along the path P. At step 330, the guide actuator 44 is advanced along a corresponding segment path 46 to align with a dispensing station atop the surface 14. At step 332, the guide actuator 44 is instructed to remain in place to hold the receptacle 16 for the dispensing operation. At step 334, a command may then be sent by the controller 202 to the corresponding dispensing station to activate a dispenser (e.g., add sugar, pour coffee, etc.). At step 336, the controller 202 receives a feedback signal from the dispensing station (or some other sensor) that the dispensing operation has been completed. At this time, the guide actuator 44 can be instructed to advance at step 338 along the segment path 46 to the next segment path 46 or further along the same segment path 46, depending on the path configuration. As indicated above, in other example, the guide actuator 44 and corresponding segment path 46 can place the receptacle 16 underneath a dispenser (or other preparation station), decouple, go do another activity, and then come back to pick-up the receptacle 16 once the dispensing operation is finished.

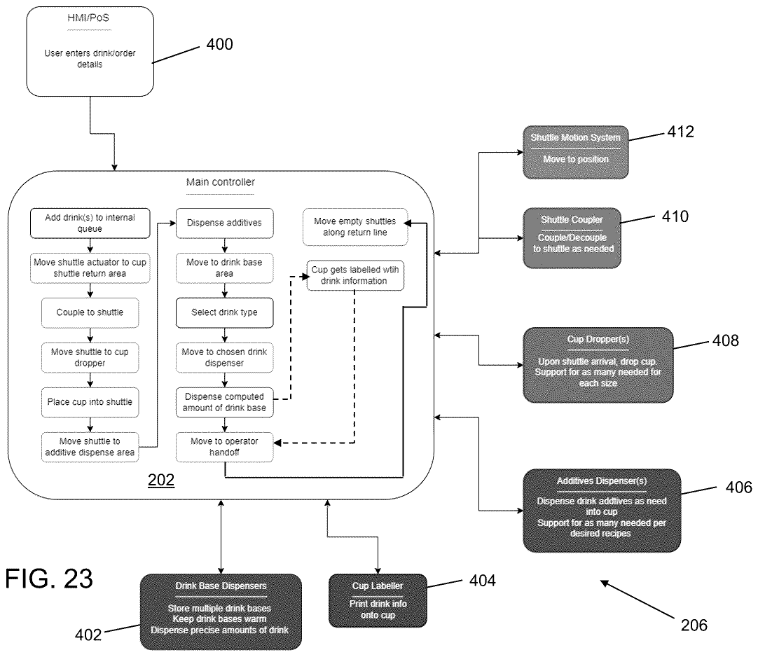

Referring now to FIG. 23, a configuration for the system is shown in which examples of dispensing devices 206 coupled to the main controller 202 are provided. In this example, the main controller 202 is also coupled to a human-machine interface (HMI) 400, which may integrated with a POS system in a retail environment as discussed below or with a kitchen display system (KDS), e.g., to take inputs from the POS and provide outputs to the KDS. The HMI 400 enables a user to enter a drink order and/or drink details, which may be fed into a routine that develops the ordering sequence 208 shown in FIG. 19. In the example configuration shown, the dispensing devices 206 include, without limitation, a drink base dispenser 402, a cup labeler 404 (which may include the dispensing/application of a label or indicia to a substrate), and an additives dispenser or multiple additive dispensers 406 (e.g., the dairy and sugar dispensers provided by way of example above). Coupled to the main controller 202 in this example are also a cup dropper 408, a shuttle coupler 410, and a shuttle motion system 412.

FIG. 23 also illustrates an example of a workflow that may be executed by the main controller 202 in a configuration such as that shown in FIGS. 1a and 2a. In this example, the receptacle 16 is referred to as a “shuttle” and such terms may be used interchangeably. In the example workflow, drink(s) is/are added to an internal queue. The shuttle actuator 44 is moved to a cup shuttle return area (e.g., region shown in leftmost area of FIG. 1a) and coupled to a shuttle 16. The shuttle 16 is moved to the cup dropper 18 and the cup dropper 18 is actuated to place the appropriately sized cup into the shuttle 16. The shuttle 16 is then moved to the additive dispenser 406 to dispense additives (e.g., milk, cream, sugar, syrup, etc.). The shuttle 16 is then moved to a drink base area (e.g., area having urns 26 shown in FIG. 1a). The drink type is selected (e.g., based on the order entered) and the shuttle 16 is moved to the appropriate drink dispenser. The computed amount of drink based (e.g., associated with an x-small, small, medium, large, x-large, etc.) is dispensed. If a labeler 204 is used (as illustrated in dashed lines), the cups is labeled with drink information and the shuttle 16 is then moved along one or more segment paths 46 to arrive at a handoff location for the operator. After the operator retrieves the prepared drink, the empty shuttle 16 is moved along a return line as discussed above.

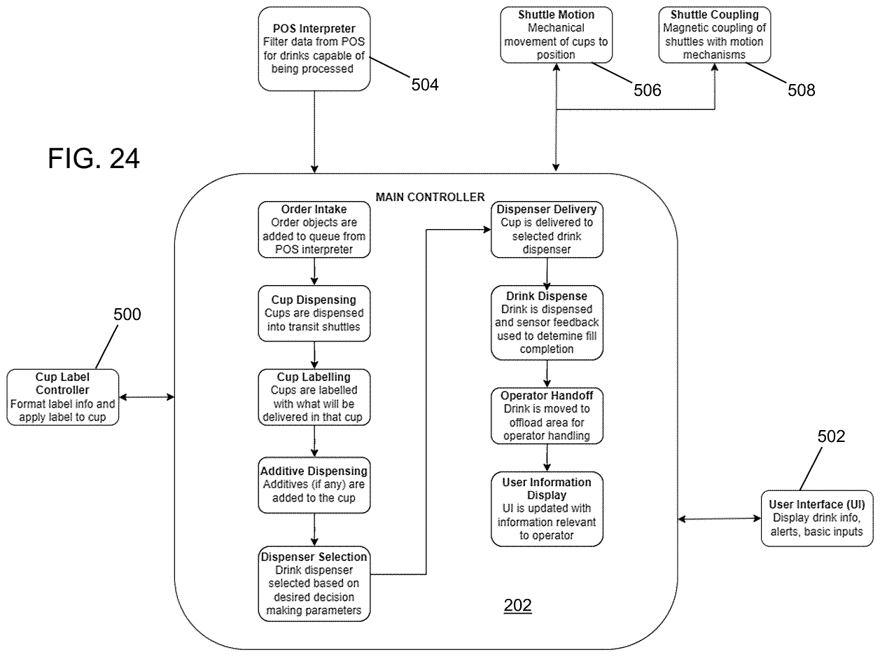

FIG. 24 illustrates an example of a workflow for the configuration shown in FIGS. 1b and 2b. In this example, the main controller 202 is interfaced with various components of the system to obtain sensor readings, provide outputs and receive other inputs. Here, a cup label controller 500 can be used to format label info and apply a label or a printed version of the contents onto the cup 20. A user interface (UI) 502 displays the drink info, the alerts and other basic inputs as illustrated by way of example below. A POS interpreter 504 filters data from the POS system for beverages capable of being processed by the automated system shown herein. Shuttle motion module 506 handles mechanical movements of the cups 20 into the various positions described herein and a shuttle coupling 508 provides magnetic coupling of the shuttles (receptacles 16) with motion mechanisms (actuators 44). The main controller operations shown in FIG. 202 begin with an order intake where order objects are added to a queue from the POS interpreter 504. Then, cup dispensing occurs wherein cups 20 are dispensed into transit shuttles (receptacles 16). Cup labelling then occurs wherein the cups 20 are labelled with what will be delivered in that cup 20. Additive dispensing then occurs where additives, if any, are added to the cup 20. The dispenser selection operation involves selecting a dispenser (urn 26) based on desired decision-making parameter(s), such as the “age” of the contents of an urn 26, its level, etc.

Next, the receptacle 16 and cup 20 are delivered to the selected drink dispenser (urn 26) and drink is dispensed. At this step, sensor feedback can be used to determine the fill completion. Operator handoff then occurs at stage 5 (see FIG. 2b) where the drink is moved to an offload area for operator handling. The UI may be updated with information relevant to the operator, e.g., to show when an order has been completed and new orders that have commenced in parallel.

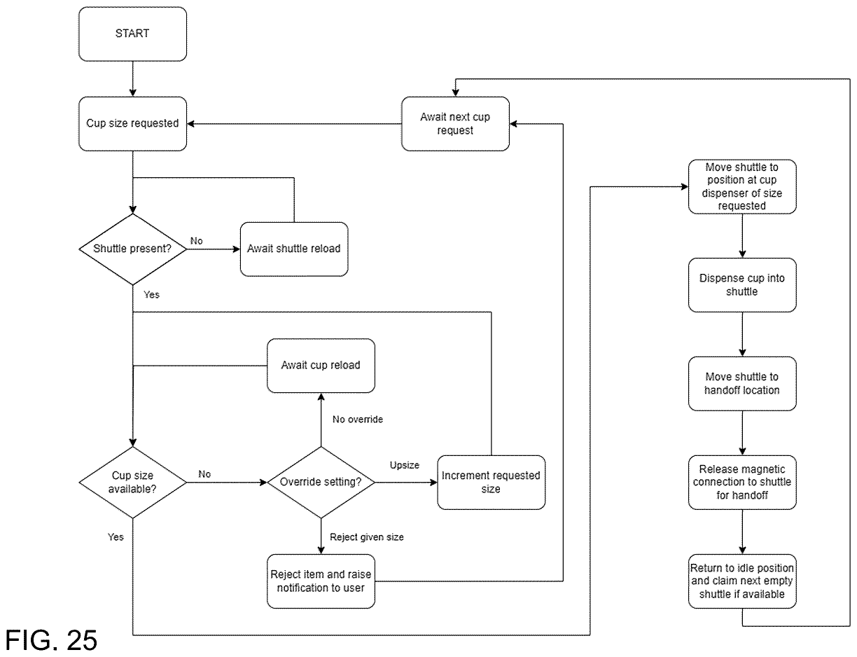

Referring now to FIGS. 25-29, flowcharts will now be described to illustrate example operations that may be performed in executing stages 1-5 (see FIG. 2b) using the system. FIG. 25 illustrates operations that may be performed in stage 1, referred to herein as the cup dropping stage. Once stage 1 starts, a cup size is requested. The system then determines if a shuttle (receptacle 16) is present. If not, the system awaits one (e.g., via the return ramp 25). Once a receptacle 16 is present, the system determines if the cup size is available. If not, the system determines if an override setting has been selected, which may include awaiting a cup reload or incrementing the requested size. For example if no small cups are available a small drink can fit into a medium cup such that a medium cup is used as an override. The override may instead include a rejected item and raise a notification to the user, which returns to a step of awaiting the next cup request. This allows the system to reject an order or have the customer choose something else. If/when a cup size is available, the shuttle (receptacle 16) is positioned beneath the appropriate cup dispenser canister 110 within the passage under the cup dropper 18. The cup 20 is then dispensed (i.e. dropped) into the receptacle 16 and the receptacle 16 is moved into the handoff location for stage 2. The actuator 44 releases the magnetic connection to the receptacle 16 for the handoff (which is picked up by an actuator 44 used for stage 2). The actuator 44 for stage 1 may then return to an idle position or proceed to pick up the next shuttle (receptacle 16) if available.

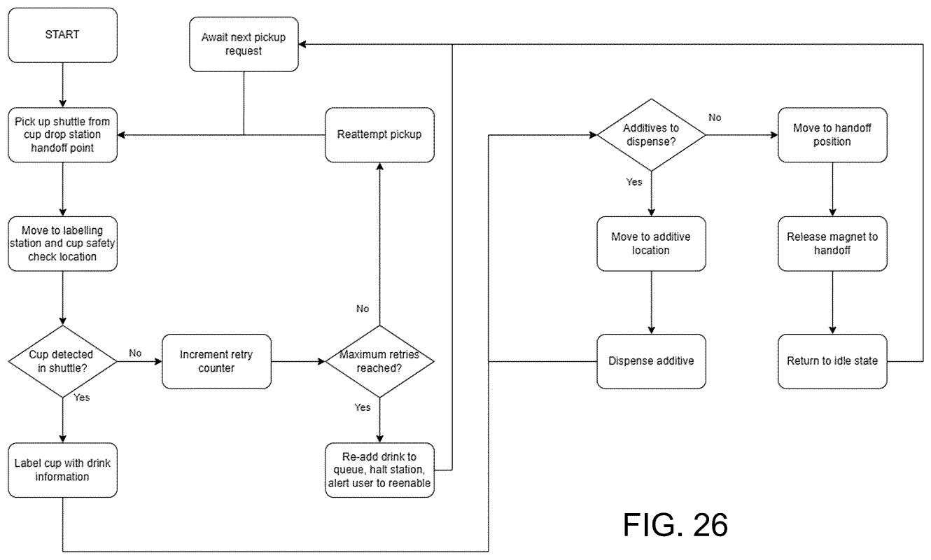

A workflow for stage 2 is illustrated in FIG. 26. Once this stage starts, the receptacle 16 is picked up from the cup drop station handoff point referred to above with respect to FIG. 25. The receptacle 16 is then moved to the labelling station and cup safety check location which may use a sensor to detect if a cup 20 is present prior to sending a command to the inkjet printer module 120. The system then confirms that a cup 20 is detected in the receptacle 16. If not, a retry counter may be incremented and, assuming a maximum number of retries has not been met or exceeded, a pickup reattempt is performed. If the cup 20 is detected, the cup is labeled, e.g., using the inkjet printer module 120, a label applicator, etc. This applies the drink information to the cup 20. Then, the system determines if there are additives to dispense. If so, the receptacle 16 is moved to the additive location and the additive is dispensed. This may repeat for multiple additives. If no additives are required or no further additives are required, the receptacle 16 is moved to the next handoff position and the actuator 44 releases it magnetic connection and returns to an idle state or proceeds immediately to pick up the next cup 20.

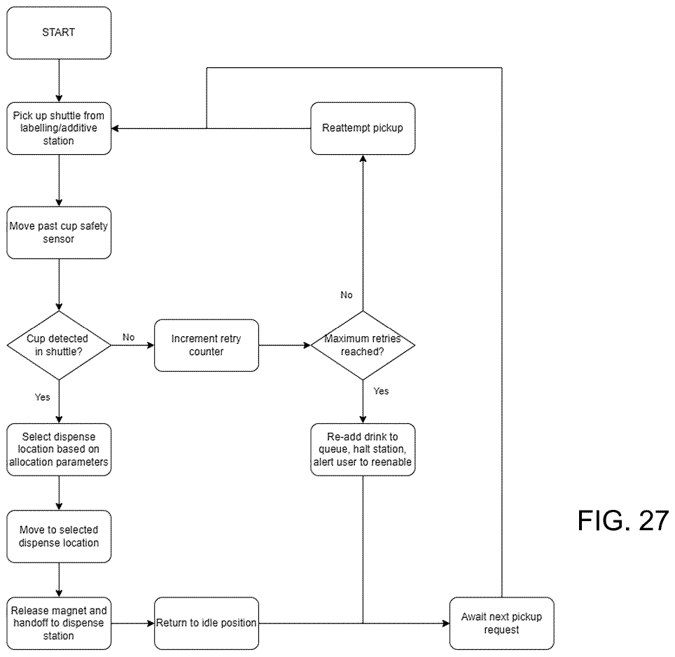

Referring now to FIG. 27, a workflow that may be implemented for performing the operations in stage 3 is shown. Once stage 3 starts, the receptacle 16 is picked up from the labelling/additive station and the cup 20 is moved past a safety sensor. This determines whether a cup 20 is in the receptacle 16. If not, a retry counter may be incremented and, within a maximum number of retries, a pickup reattempt may be tried. Once a maximum number of retries occurs, the drink may be re-added to the queue, the station halted and an alert provided to the user to reenable. Once a cup 20 is detected, the a dispense location is selected based on allocation parameters. For example, the urn 26 with the appropriate drink type would be selected. Moreover, if there are multiple urns 26 with the same drink type, a particular one of the urns 26 may be selected based on criteria such as age, fill level, etc. The receptacle 16 is then moved to the selected dispense location and the magnetic connection is released to handoff to the next stage. The actuator 44 then returns to its idle position to await the next pickup or immediately initiates the next pickup operation.

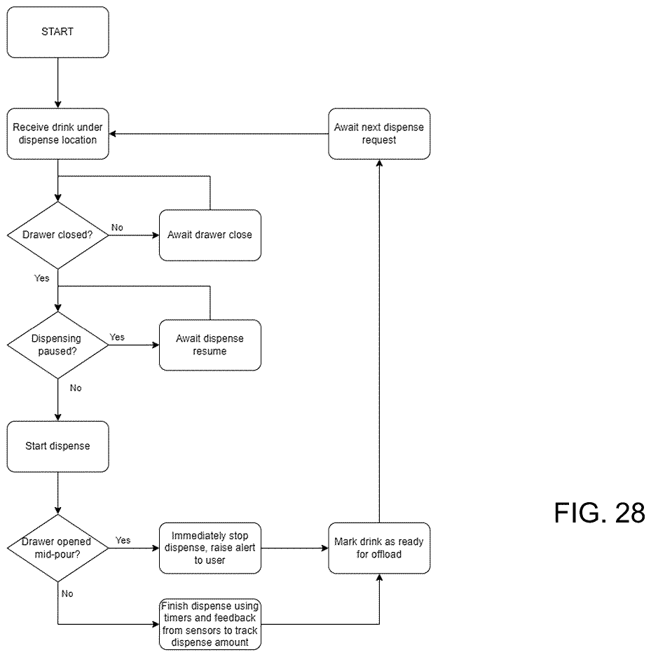

FIG. 28 illustrates operations that may be performed in the dispensing stage 4. Once this stage starts, the system detects that a cup 20 is received under a particular dispense location. The system then confirms that the drawer (shelf 50) is closed. If not, the system awaits closure of the drawer. When the drawer is closed, the system determines if the dispensing operation has been paused by the user or an outside system. If so, the urn 26 awaits a dispense resume signal. If dispensing has not been, or is no longer, paused the dispense operation starts. If the drawer is opened mid-pour, the dispense operation is immediately stopped and an alert raised to avoid spillage and the drink is marked as being ready to offload, in this case to remedy a potential error. Assuming the drawer is not opened mid-pour, the dispense operation is finished using a timer and feedback from sensors to track the dispense amount. The drink is then marked as ready to offload and the dispense station awaits the next dispense request. It can be appreciated that if multiple cups 20 are positioned within the dispense area at the same time, at least some of these operations may be repeated in parallel at different urns 26 to increase throughput.

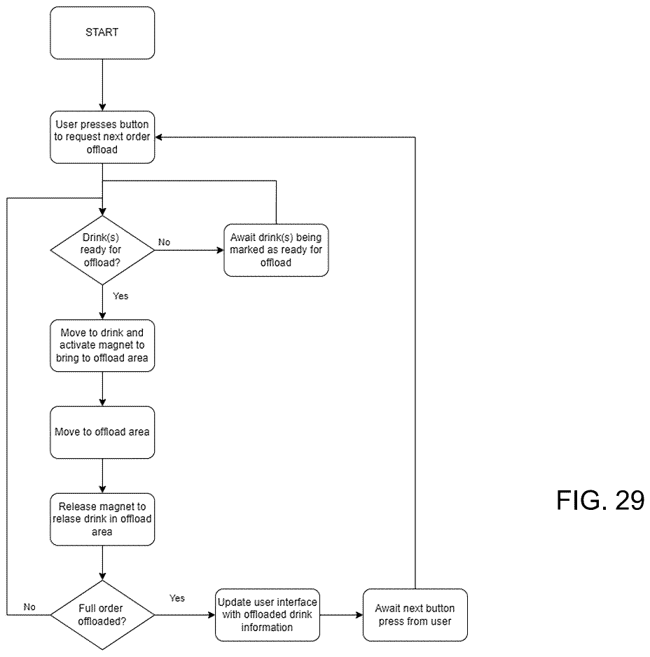

FIG. 29 illustrates the offload stage 5. This stage may be initiated by the user pressing a button to request the next order offload. Since multiple cups 20 may be in the dispensing station, but not all from the same order, the gantry 47 can be used to selectively pickup the specific cups 20 for the requested order and bring then to the offload area. The system determines if the drinks are ready to offload. If not, the system awaits an indication that they are ready. This may be affected by outside factors such as bottlenecks in the user workflow, customer delays, etc. Once the drinks are ready to be offloaded, the drink(s) is/are moved by the gantry 47 and its actuators 44 by activating the magnetic connections for the specific cup(s) 20 to move one or more cups 20 to the offload area in unison. The magnets are released to leave the cups 20 in the offload area. If the full order is not offloaded, the gantry 47 may be used to return to the dispensing area to pick up a drink 20 that has been added to an order, was longer in preparing etc. In another example, the full order may include food or other items that need to be gathered by the user before the drinks are served to the customer. Once the order has been offloaded the user interface is updated with the offloaded drink information and the system awaits the next button press by the user to request the next order.

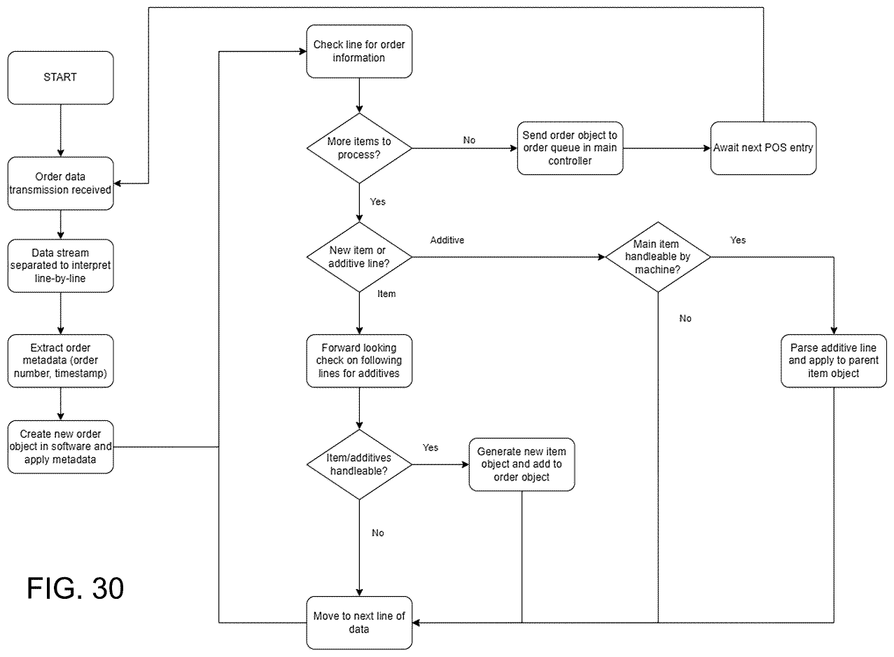

As discussed above, the system described herein may be integrated at least in part with an existing POS system, to translate and transfer order details to the system for use in automating the drink preparation. Turning now to FIG. 30, a flow chart is provided illustrating an example of such an integration with the POS system. The process begins by receiving an order data transmission from the POS system. The data stream is interpreted line-by-line to extract order metadata such as the order number, timestamp, etc. The system may then create a new order object in its software and apply the metadata. The lines are then checked one by one for order information. If there is an item to process (or more items to process), the system determines if the line indicates a new item or an additive line. If additive, the controller 202 determines if the main item is handleable by the system. If so, the additive line is parsed and applied to the main item object. If the system is processing a new item, the system performs a forward-looking check on the following lines to determine if there are additives to be expected. For example, a medium dark roast coffee may include additives such as dairy and/or sugar which are factored into the sequence of steps required to prepare that item in the order. If the item can be handled, a new item object is generated and added to the order object. The process then proceeds to move to the next line of the data until all items and additives are parsed and accounted for, thus translating and transfer the order details into instructions for a next order to be processed by the system.

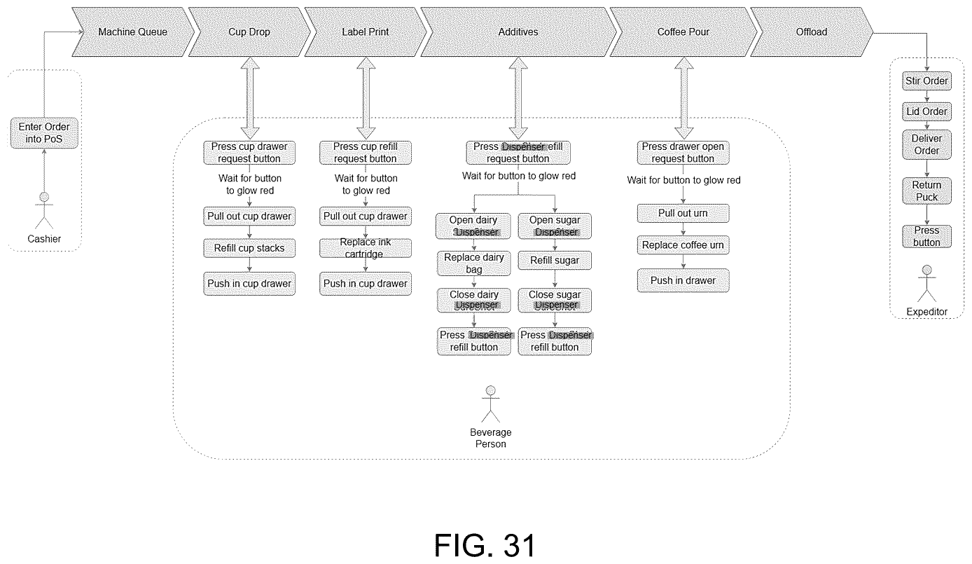

FIG. 31 illustrates various user interactions that may occur in line with the stages provided by way of example above. In this example, a user (cashier) enters an order in the POS system. This enters a machine queue that is parsed as shown in FIG. 30. At the cup drop station the user presses the cup drawer request button and waits for the button to light up (e.g., red). The cup drawer is pulled out and cup stacks may be refilled and the cup drawer pushed in. At the label print station, the user may select the same button to replace an ink cartridge when the cup drawer has been pulled out to access the inkjet printer module 120. At the additives station, the user may select a dispensing station refill button and open either machine to replace the contents (dairy, sugar, etc.) and close the dispensers. This may be performed by a beverage preparation employee. At the coffee pouring/dispensing station, a drawer button may be pressed to enable an urn 26 to be pulled out using a drawer like mechanism on the shelf 50. This allows the beverage preparation employee to replace an urn 26 and then close the drawer for operation. An expeditor or server may interact with the offload station to stir and lid an order, unless an automated station is provided. The server may then deliver the order and return the receptacle 16 to the cup drop station using the return ramp 25. This user may also operate the UI to request the next order.

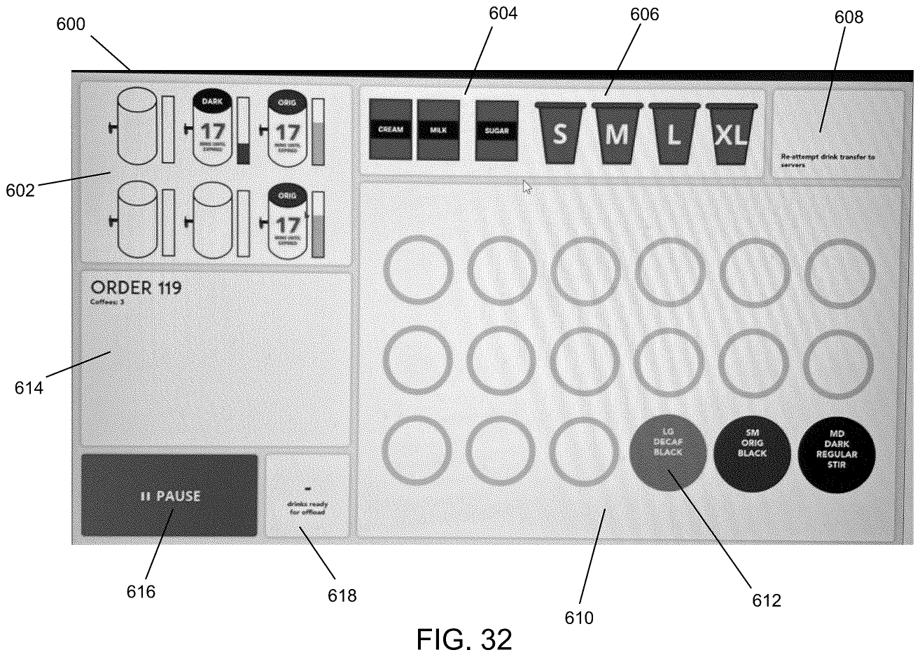

FIG. 32 provides a screen shot of an example of the UI 600. In this example, the UI 600 may include a number of touch-capable portions which include interactive elements or input buttons. An urn status portion 602 may be shown to include details of each urn 26 that is online, including the type of beverage, the number of minutes remaining until the contents are “expired” and fill levels. These can be color-coded to indicate levels of urgency for replacement, etc. A dispenser status portion 604 may be used to similarly show which dispensers 22, 24 are being used, what the contents are, and fill levels, etc. A cup dropper portion 606 may also be provided to track the number of cups 20 present of each denomination and to track when a refill operation may be required. A re-attempt button 608 is provided in this example, when a drink transfer requires another attempt. An order details portion 614 provides the contents of an order and may be used to show the status. For example, other order items not handled by the system may have a parallel workflow and the UI 600 may receive external updates on order item status, such as a baked good or sandwich that would be delivered to a customer at the same time as a beverage prepared by the system. An item status portion 610 allows the UI 600 to show which items 612 are being prepared, and some details about those items. The items shown in this portion 610 may be from different orders.

The UI 600 may include various other status and control functions and may include multiple different screens. Moreover, the UI 600 may be displayed on the screen 150 of the UI box 27 as well as on other screens throughout a food preparation location. The UI box 27 may be positioned as shown in FIG. 2b or in another orientation, e.g., along the length of the system or elsewhere and positioned in different orientations and angles. Similarly, the offload station, while shown at the far left may be at the far right, that is, the system can be reconfigured to move the cups 20 along in the opposite direction. The offload station may be oriented outwardly towards the end or be oriented normal thereto depending on the desired positioning of the user.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing system 50, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. An automated system for food and/or beverage preparation, comprising:
a plurality of path segments that together form a path between a plurality of preparation stations, the path segments being positioned above or beneath a surface on which the preparation stations are positioned, each path segment comprising:
a segment path element;
a guide actuator moveable along the segment path element; and
a magnetic guide, the magnetic guide being controllable to couple the magnetic guide to a magnetic portion of an object placed above or below the magnetic guide on the surface;
wherein at least one segment provides two-dimensional movements of at least one magnetic guide to permit non-linear advancement of the object between at least two positions; and
a computing system, the computing system being connected to the guide actuator of each of the plurality of path segments, the computing system comprising a controller operable to have the guide actuator move along its segment path element and operable to couple and decouple the magnetic guide to selectively interact with the object, wherein the computing system is coupled to at least one dispensing equipment at a corresponding preparation station to selectively operate the dispensing equipment when the receptacle is positioned at that station.

2. The system of claim 1, wherein the path segments are positioned beneath the surface.

3. The system of claim 1, wherein the object placed above the magnetic guide on the surface comprises a receptacle.

4. The system of claim 1, wherein the computing system further comprises a main controller coupled to a plurality of sensor and actuator controllers to control the guide actuators according to sensor inputs.

5. The system of claim 4, wherein the main controller is coupled to a machine vision system to apply a food/beverage item recognition program as an input to determine a preparation sequence.

6. The system of claim 1, further comprising a user interface coupled to the controller.

7. The system of claim 1, further comprising at least one data interface to obtain data from an existing point of sale (POS) system to obtain order information to automatically instruct the system.

8. The system of claim 1, further comprising a network data interface for communicating between multiple electro-mechanical systems.

9. The system of claim 1, further comprising an indexing mechanism to determine a position of the guide actuators.

10. The system of claim 1, wherein the object comprises a receptacle to interact with the magnetic guide, the receptacle configured to receive a cup into which contents are dispensed from the preparation stations.

11. The system of claim 10, comprising a cup dropping station, the cup dropping station being activated to drop the cup into the receptacle.

12. The system of claim 10, comprising at least one beverage dispensing station elevated relative to the cup, the system being configured to move the cup into alignment with the beverage dispensing station.

13. The system of claim 10, further comprising an offload station on the surface for accommodating at least one cup and receptacle subsequent to being subjected to at least one of the preparation stations.

14. The system of claim 1, further comprising a return path for automatically returning the object from an end station to a beginning station.

15. The system of claim 1, wherein the surface is provided in an enclosed unit that is supportable upon an existing surface.

16. The system of claim 1, wherein at least one preparation station comprises a valve, the valve being automatically operated by a valve actuator connected to a controller in the system.

17. The system of claim 1, comprising a labelling or printing station comprising a printer or labeler that is automatically activated to apply information to an item coupled to and carried by the object between the preparation stations.

18. The system of claim 1, further comprising a user interface module to provide a screen to interface with at least some of the preparation stations.

19. The system of claim 1, wherein at least one preparation station comprises a plurality of liquid dispensers positioned above the surface to permit the object, loaded with a cup, to be positioned beneath a selected one of the liquid dispensers.

20. The system of claim 19, wherein a plurality of objects with cups are positioned under respective liquid dispensers at the same time, and wherein at least two objects are moved from the preparation station to another station at the same time.
